(19) United States
(12) Patent Application Publication
(10) Pub. No.: US 2025/0251827 A1
(43) Pub. Date: Aug. 7, 2025

(54) ELECTRONIC DEVICE

(71) Applicant: SAMSUNG DISPLAY CO., LTD., YONGIN-SI (KR)

(72) Inventor: SANGHYUN LIM, YONGIN-SI (KR)

(21) Appl. No.: 18/887,161

(22) Filed: Sep. 17, 2024

(30) Foreign Application Priority Data
Feb. 6, 2024 (KR) 10-2024-0018144

(51) Int. Cl. G06F 3/041; G06F 3/044

(52) U.S. Cl. CPC G06F 3/04166; G06F 3/04164; G06F 3/0446; G06F 2203/04106; G06F 2203/04111; G06F 2203/04114

(57) ABSTRACT

An electronic device includes a sensor layer and a sensor driver configured to drive the sensor layer and operate in one of a first mode for sensing a touch input and a second mode for sensing a pen input. The sensor layer includes a plurality of first electrode groups arranged along a first direction and a plurality of second electrode groups arranged along a second direction crossing the first direction and each including a first sensing electrode and a second sensing electrode. A plurality of coupling capacitors are between the first sensing electrode and the second sensing electrode.

### CROSS-REFERENCE TO RELATED APPLICATIONS

This U.S. non-provisional patent application claims priority under 35 U.S.C. § 119 to Korean Patent Application No. 10-2024-0018144, filed on Feb. 6, 2024, the disclosure of which is incorporated by reference in its entirety herein.

### 1. TECHNICAL FIELD

The present disclosure is directed to an electronic device capable of sensing an input by a pen.

### 2. DISCUSSION OF RELATED ART

Multimedia electronic devices such as televisions, mobile phones, tablet computers, laptops, navigation devices, and game consoles include a display device for displaying an image. The electronic devices may include a touch-based input system for enabling a user to intuitively, and conveniently input information or a command, different from a general input system such as a button, a keyboard or a mouse.

A sensor layer of the touch-based input system may sense a touch or pressure of an object (e.g., a finger or pen). For example, the pen may be used for sketching or drawings. However, it may be difficult to sense the pen due to noise.

### SUMMARY

The present disclosure provides an electronic device capable of sensing an input by a pen.

An embodiment of the inventive concept provides an electronic device including a sensor layer, and a sensor driver configured to drive the sensor layer and operate in one of a first mode for sensing a touch input and a second mode for sensing a pen input. For example, the sensor driver may selectively operate in the first mode or the second mode. The sensor layer includes a plurality of first electrode groups arranged along a first direction, and a plurality of second electrode groups arranged along a second direction crossing the first direction, crossing the plurality of first electrode groups, and each including a first sensing electrode and a second sensing electrode. The first sensing electrode includes a first division electrode, and a first cross electrode electrically connected to the first division electrode. The second sensing electrode includes a second division electrode spaced apart from the first division electrode in the first direction, and a second cross electrode electrically connected to the second division electrode. At least a portion of the first cross electrode overlaps the second division electrode, and at least a portion of the second cross electrode overlaps the first division electrode.

In an embodiment, in the second mode, the sensor driver may be configured to receive a first signal from the first sensing electrode and receive a second signal from the second sensing electrode.

In an embodiment, the sensor layer may further include a first crossing trace line electrically connected to the first sensing electrode and a second crossing trace line electrically connected to the second sensing electrode, the first crossing trace line may be connected to the first division electrode, and the second crossing trace line may be connected to the second division electrode.

In an embodiment, the first crossing trace line may be connected to one end of the first division electrode, and the second crossing trace line may be connected to one end of the second division electrode.

In an embodiment, a length of the first cross electrode in the first direction may be smaller than a length of the second division electrode in the first direction, and a length of the second cross electrode in the first direction may be smaller than a length of the first division electrode in the first direction.

In an embodiment, a maximum width of the first cross electrode in the second direction may be smaller than a maximum width of the second division electrode in the second direction, and a maximum width of the second cross electrode in the second direction may be smaller than a maximum width of the first division electrode in the second direction.

In an embodiment, the sensor driver may include a differential amplifier, and in the second mode, an inverting terminal of the differential amplifier may be electrically connected to the first sensing electrode, and a non-inverting terminal of the differential amplifier may be electrically connected to the second sensing electrode.

In an embodiment, the sensor driver may include a first differential amplifier, a second differential amplifier, and a third differential amplifier, and in the second mode, each of the first differential amplifier and the second differential amplifier may receive signals from the plurality of second electrode groups, an inverting terminal of the third differential amplifier may receive a signal outputted from the first differential amplifier, and a non-inverting terminal of the third differential amplifier may receive a signal outputted from the second differential amplifier.

In an embodiment, the plurality of second electrode groups may include a (2-1)-th electrode group and a (2-2)-th electrode group spaced apart from the (2-1)-th electrode group in the second direction, in the second mode, an inverting terminal of the first differential amplifier may be electrically connected to the first sensing electrode of the (2-1)-th electrode group, and a non-inverting terminal of the first differential amplifier may be electrically connected to the second sensing electrode of the (2-1)-th electrode group, and in the second mode, an inverting terminal of the second differential amplifier may be electrically connected to the first sensing electrode of the (2-2)-th electrode group, and a non-inverting terminal of the second differential amplifier may be electrically connected to the second sensing electrode of the (2-2)-th electrode group.

In an embodiment, the plurality of second electrode groups may include a (2-1)-th electrode group and a (2-2)-th electrode group spaced apart from the (2-1)-th electrode group in the second direction, in the second mode, an inverting terminal of the first differential amplifier may be electrically connected to the first sensing electrode of the (2-2)-th electrode group, and a non-inverting terminal of the first differential amplifier may be electrically connected to the first sensing electrode of the (2-1)-th electrode group, and in the second mode, an inverting terminal of the second differential amplifier may be electrically connected to the second sensing electrode of the (2-1)-th electrode group, and a non-inverting terminal of the second differential amplifier may be electrically connected to the second sensing electrode of the (2-2)-th electrode group.

In an embodiment, the sensor driver may include a plurality of differential amplifiers and an analog-to-digital converter, in the second mode, the plurality of differential amplifiers may be connected, in one-to-one correspondence, to the plurality of first sensing electrodes and the plurality of second sensing electrodes of the plurality of second electrode groups, the analog-to-digital converter may receive a plurality of signals from the plurality of differential amplifiers, and the sensor driver may perform a difference operation on data outputted from the analog-to-digital converter.

In an embodiment, each of the plurality of first electrode groups may include a third sensing electrode and a fourth sensing electrode, the third sensing electrode may include a third division electrode and a third cross electrode electrically connected to the third division electrode, the fourth sensing electrode may include a fourth division electrode spaced apart from the third division electrode in the first direction, and a fourth cross electrode electrically connected to the fourth division electrode, and at least a portion of the third cross electrode may overlap the fourth division electrode, and at least a portion of the fourth cross electrode may overlap the third division electrode.

In an embodiment, in the second mode, the sensor driver may be configured to receive a first signal from the first sensing electrode, receive a second signal from the second sensing electrode, receive a third signal from the third sensing signal, and receive a fourth signal from the fourth sensing electrode.

In an embodiment, the first division electrode may include a plurality of (1-1)-th sensing patterns and a (1-1)-th bridge pattern, and the first cross electrode may include a plurality of (1-2)-th sensing patterns and a (1-2)-th bridge pattern, the second division electrode may include a plurality of (2-1)-th sensing patterns and a (2-1)-th bridge pattern, and the second cross electrode may include a plurality of (2-2)-th sensing patterns and a (2-2)-th bridge pattern, the third division electrode may include a plurality of (3-1)-th sensing patterns and a (3-1)-th bridge pattern, and the third cross electrode may include a plurality of (3-2)-th sensing patterns and a (3-2)-th bridge pattern, and the fourth division electrode may include a plurality of (4-1)-th sensing patterns and a (4-1)-th bridge pattern, and the fourth cross electrode may include a plurality of (4-2)-th sensing patterns and a (4-2)-th bridge pattern.

In an embodiment, the plurality of (1-1)-th sensing patterns, the (1-1)-th bridge pattern, the (1-2)-th bridge pattern, the plurality of (2-1)-th sensing patterns, the (2-1)-th bridge pattern, the (2-2)-th bridge pattern, the plurality of (3-1)-th sensing patterns, and the plurality of (4-1)-th sensing patterns may be disposed on a same first layer, and the plurality of (1-2)-th sensing patterns, the plurality of (2-2)-th sensing patterns, the plurality of (3-2)-th sensing patterns, the (3-1)-th bridge pattern, the (3-2)-th bridge pattern, the plurality of (4-2)-th sensing patterns, the (4-1)-th bridge pattern, and the (4-2)-th bridge pattern may be disposed on a same second layer.

In an embodiment, the plurality of (1-2)-th sensing patterns may overlap some (2-1)-th sensing patterns among the plurality of (2-1)-th sensing patterns, and the plurality of (2-2)-th sensing patterns may overlap some (1-1)-th sensing patterns among the plurality of (1-1)-th sensing patterns, and the plurality of (3-2)-th sensing patterns may overlap some (4-1)-th sensing patterns among the plurality of (4-1)-th sensing patterns, and the plurality of (4-2)-th sensing patterns may overlap some (3-1)-th sensing patterns among the plurality of (3-1)-th sensing patterns.

In an embodiment, the sensor layer may further include a dummy electrode including a plurality of first dummy patterns and a plurality of second dummy patterns, the first dummy patterns may include patterns having a same shape as a shape of at least a portion among the (1-2)-th sensing patterns, the (2-2)-th sensing patterns, the (3-2)-th sensing patterns, and the (4-2)-th sensing patterns, and the second dummy patterns may include patterns having a same shape as a shape of at least a portion among the (1-2)-th bridge pattern, the (2-2)-th bridge pattern, the (3-2)-th bridge pattern, and the (4-2)-th bridge pattern.

In an embodiment, the sensor layer may further include a plurality of auxiliary electrodes respectively overlapping the plurality of first electrode groups, and a connection trace line connecting the plurality of auxiliary electrodes to each other.

In an embodiment, the sensor layer may further include a plurality of first trace lines electrically connected, in one-to-one correspondence, to the plurality of first electrode groups, and the plurality of first trace lines may be spaced apart from the connection trace line with the plurality of first electrode groups therebetween.

In an embodiment, the first division electrode may include a plurality of (1-1)-th sensing patterns and a (1-1)-th bridge pattern, and the first cross electrode may include a plurality of (1-2)-th sensing patterns and a (1-2)-th bridge pattern, the second division electrode may include a plurality of (2-1)-th sensing patterns and a (2-1)-th bridge pattern, and the second cross electrode may include a plurality of (2-2)-th sensing patterns and a (2-2)-th bridge pattern, each of the plurality of first electrode groups may include a plurality of third sensing patterns and a third bridge pattern, the plurality of (1-1)-th sensing patterns, the (1-1)-th bridge pattern, the (1-2)-th bridge pattern, the plurality of (2-1)-th sensing patterns, the (2-1)-th bridge pattern, the (2-2)-th bridge pattern, and the plurality of third sensing patterns may be disposed on a same first layer, and the plurality of (1-2)-th sensing patterns, the plurality of (2-2)-th sensing patterns, the third bridge pattern, and the plurality of auxiliary electrodes may be disposed on a same second layer.

In an embodiment, the plurality of third sensing patterns may overlap one corresponding auxiliary electrode among the plurality of auxiliary electrodes, and at least one hole surrounding the third bridge pattern may be in the one auxiliary electrode.

In an embodiment, the sensor layer may further include a plurality of loop trace lines electrically connected to the plurality of auxiliary electrodes, the second mode may include a charge driving mode and a pen sensing driving mode, the sensor driver may be configured to apply a first signal to at least one among the connection trace line and the plurality of loop trace lines and apply a second signal to another at least one among the connection trace line and the plurality of loop trace lines in the charge driving mode, and in the pen sensing driving mode, all the plurality of loop trace lines may be floated.

In an embodiment, the sensor driver may include a differential amplifier, and in the first mode, an inverting terminal of the differential amplifier may be electrically connected to the first sensing electrode and the second sensing electrode.

In an embodiment, the sensor driver may include a first differential amplifier, a second differential amplifier, a first analog-to-digital converter, and a second analog-to-digital converter, in the first mode, an inverting terminal of the first differential amplifier may be electrically connected to the first sensing electrode, and an inverting terminal of the second differential amplifier may be electrically connected to the second sensing electrode, the first analog-to-digital converter may receive a signal from the first differential amplifier, and the second analog-to-digital converter may receive a signal from the second differential amplifier, and the sensor driver may sum data outputted from the first analog-to-digital converter and from the second analog-to-digital converter.

In an embodiment, in the first mode, the sensor driver may provide a same signal to the first sensing electrode and the second sensing electrode, and receive signals provided from the plurality of first electrode groups.

In an embodiment of the inventive concept, an electronic device includes a sensor layer and a sensor driver configured to drive the sensor layer and operate in one of a first mode for sensing a touch input and a second mode for sensing a pen input. The sensor layer includes a plurality of first electrode groups arranged along a first direction, and a plurality of second electrode groups arranged along a second direction crossing the first direction and crossing the plurality of first electrode groups, and each of the plurality of second electrode groups includes a first sensing electrode and a second sensing electrode, and a plurality of coupling capacitors are between the first sensing electrode and the second sensing electrode.

In an embodiment, the first sensing electrode may include a first division electrode, and a first cross electrode electrically connected to the first division electrode, the second sensing electrode may include a second division electrode spaced apart from the first division electrode in the first direction, and a second cross electrode electrically connected to the second division electrode, and the plurality of coupling capacitors may include a first coupling capacitor defined between the first division electrode and the second cross electrode and a second coupling capacitance defined between the second division electrode and the first cross electrode.

In an embodiment, in the second mode, the sensor driver may be configured to receive a first signal from the first sensing electrode and receive a second signal from the second sensing electrode.

In an embodiment of the inventive concept, an electronic device includes a sensor layer, and a sensor driver configured to drive the sensor layer and operate in one of a first mode for sensing a touch input and a second mode for sensing a pen input. The sensor layer includes a plurality of first electrode groups arranged along a first direction, and a plurality of second electrode groups arranged along a second direction crossing the first direction and crossing the plurality of first electrode groups. Each of the plurality of second electrode groups includes a first division electrode and a second division electrode spaced apart from each other in the first direction. In the second mode, the sensor driver is configured to receive a first signal from the first division electrode, and receive a second signal from the second division electrode.

In an embodiment, each of the plurality of second electrode groups may further include a first cross electrode electrically connected to the first division electrode, and a second cross electrode electrically connected to the second division electrode, and at least a portion of the first cross electrode may overlap the second division electrode, and at least a portion of the second cross electrode may overlap the first division electrode.

### BRIEF DESCRIPTION OF THE FIGURES

The above and other objects and features of the present disclosure will become apparent by describing in detail embodiments thereof with reference to the accompanying drawings. In the drawings:

FIG. 1A is a perspective view of an electronic device according to an embodiment of the inventive concept;

FIG. 1B is a rear perspective view of an electronic device according to an embodiment of the inventive concept;

FIG. 2 is a perspective view of an electronic device according to an embodiment of the inventive concept;

FIG. 3 is a schematic cross-sectional view of a display panel according to an embodiment of the inventive concept;

FIG. 4 is a diagram illustrating an operation of an electronic device according to an embodiment of the inventive concept;

FIG. 5A is a diagram illustrating a pen according to an embodiment of the inventive concept;

FIG. 5B is a diagram illustrating a pen according to an embodiment of the inventive concept;

FIG. 5C is a diagram illustrating a pen according to an embodiment of the inventive concept;

FIG. 5D is a diagram illustrating an input device according to an embodiment of the inventive concept;

FIG. 6 is a cross-sectional view of a display panel according to an embodiment of the inventive concept;

FIG. 7 is a plan view of a sensor layer according to an embodiment of the inventive concept;

FIG. 8 is a diagram illustrating an operation of a sensor driver according to an embodiment of the inventive concept;

FIG. 9 is a diagram illustrating an operation of a sensor driver according to an embodiment of the inventive concept;

FIG. 10A is a diagram illustrating one electrode group and a portion of a sensor driver according to an embodiment of the inventive concept;

FIG. 10B is a diagram illustrating a portion of one electrode group according to an embodiment of the inventive concept;

FIG. 11 is an equivalent circuit diagram illustrating a relationship between one electrode group and a pen according to an embodiment of the inventive concept;

FIG. 12 is a graph showing a magnitude of current versus a position of a pen with respect to one channel;

FIG. 13 is a graph showing a magnitude of an output signal versus a position of a pen with respect to one channel;

FIG. 14 is a diagram illustrating four electrode groups and a portion of a sensor driver according to an embodiment of the inventive concept;

FIG. 15 is a diagram illustrating four electrode groups and a portion of a sensor driver according to an embodiment of the inventive concept;

FIG. 16A is a diagram illustrating current sensed in a plurality of electrode groups;

FIG. 16B is a diagram illustrating current obtained from a differential pair of a plurality of electrode groups;

FIG. 17 is a diagram illustrating four electrode groups and a portion of a sensor driver according to an embodiment of the inventive concept;

FIG. 18 is a plan view illustrating a portion of a sensor layer according to an embodiment of the inventive concept;

FIG. 19 is a plan view illustrating four sensing units according to an embodiment of the inventive concept;

FIG. 20A is a plan view illustrating a second conductive layer of a sensing unit according to an embodiment of the inventive concept;

FIG. 20B is a plan view illustrating a first conductive layer of a sensing unit according to an embodiment of the inventive concept;

FIG. 20C is a plan view illustrating four sensing units according to an embodiment of the inventive concept;

FIG. 21 is a plan view illustrating a portion of a sensor layer according to an embodiment of the inventive concept;

FIG. 22 is a schematic diagram illustrating one channel according to an embodiment of the inventive concept;

FIG. 23 is an equivalent circuit diagram illustrating a relationship between one channel and a pen according to an embodiment of the inventive concept;

FIG. 24A is a graph showing a magnitude of current versus a position of a pen with respect to one channel;

FIG. 24B is a graph showing a magnitude of a signal versus a position of a pen with respect to one channel;

FIG. 25 is a plan view illustrating four sensing units according to an embodiment of the inventive concept;

FIG. 26A is a plan view illustrating a second conductive layer of four sensing units according to an embodiment of the inventive concept;

FIG. 26B is a plan view illustrating a first conductive layer of four sensing units according to an embodiment of the inventive concept;

FIG. 27 is a plan view illustrating a portion of a sensor layer and a portion of a sensor driver according to an embodiment of the inventive concept;

FIG. 28 is a plan view illustrating a portion of a sensor layer and a portion of a sensor driver according to an embodiment of the inventive concept;

FIG. 29 is a plan view illustrating a portion of a sensor layer and a portion of a sensor driver according to an embodiment of the inventive concept; and

FIG. 30 is a plan view illustrating a portion of a sensor layer and a portion of a sensor driver according to an embodiment of the inventive concept.

### DETAILED DESCRIPTION

In this specification, it will be understood that when an element (or a region, a layer, a portion, or the like) is referred to as being “on”, “connected to” or “coupled to” another element, it may be directly disposed on, connected or coupled to the other element, or an intervening element may be disposed therebetween.

Like reference numerals or symbols refer to like elements. The term “and/or” includes all of one or more combinations which may be defined by related elements. The singular forms include the plural forms as well unless the context clearly indicates otherwise.

The terms “part” and “unit” mean a software component or a hardware component for performing a specific function. The hardware component may include, for example, a field-programmable gate array (FPGA) or an application-specific integrated circuit (ASIC). The software component may refer to executable code and/or data used by executable code in an addressable storage medium. Thus, software components may be, for example, object-oriented software components, class components, and task components, and may include processes, functions, attributes, procedures, subroutines, program code segments, drivers, firmware, microcode, circuits, data, database, data structures, tables, arrays, or variables.

Hereinafter, embodiments of the inventive concept will be described with reference to the accompanying drawings.

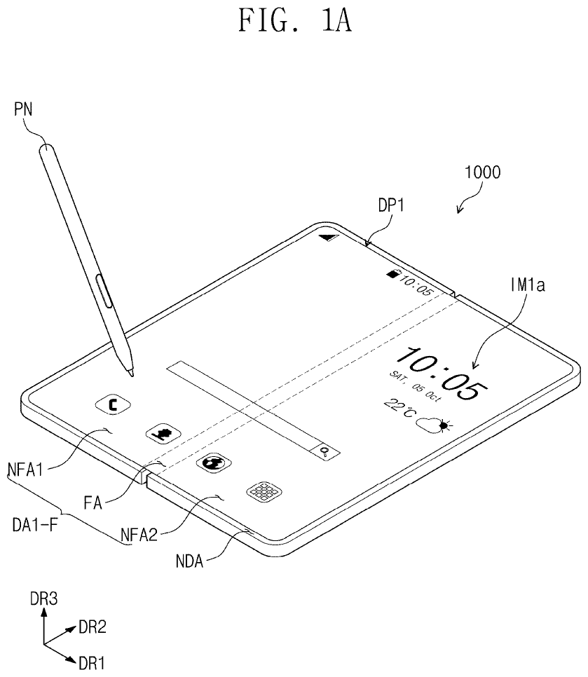

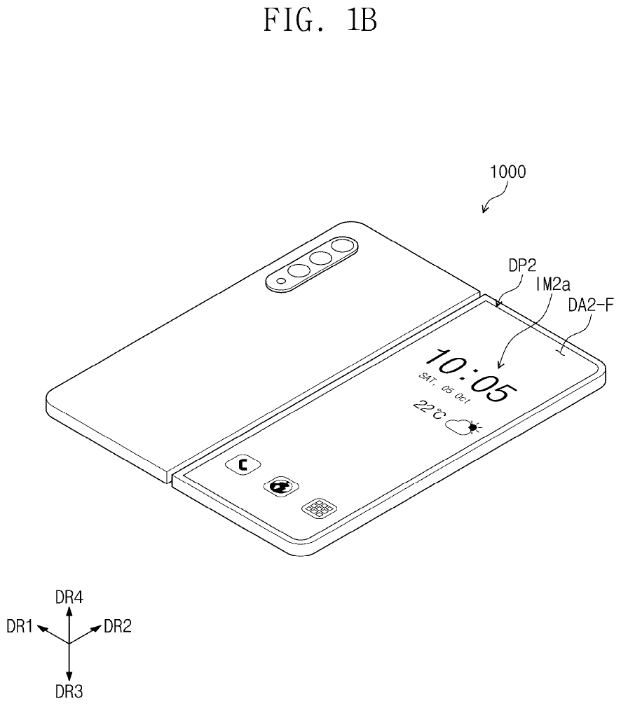

FIG. 1A is a perspective view of an electronic device 1000 according to an embodiment of the inventive concept. FIG. 1B is a rear perspective view of an electronic device 1000 according to an embodiment of the inventive concept.

Referring to FIGS. 1A and 1B, the electronic device 1000 may be activated in response to an electrical signal. For example, the electronic device 1000 may display an image and sense inputs applied from the outside. The external input may be a user's input. A user's input may include external inputs in various forms such as a part of a user's body, a pen PN, light, heat, or pressure.

The electronic device 1000 may include a first display panel DP1 and a second display panel DP2. The first display panel DP1 and the second display panel DP2 may be separate panels separated from each other. The first display panel DP1 may be referred to as a main display panel, and the second display panel DP2 may be referred to as an auxiliary display panel or an external display panel.

The first display panel DP1 may include a first display portion DA1-F, and the second display panel DP2 may include a second display portion DA2-F. An area size of the second display panel DP2 may be smaller than an area size of the first display panel DP1. In correspondence with sizes of the first display panel DP1 and the second display panel DP2, an area size of the first display portion DA1-F may be greater than an area size of the second display portion DA2-F.

In an unfolded state of the electronic device 1000, the first display portion DA1-F may be arranged in a plane substantially parallel to a first direction DR1 and a second direction DR2. A thickness direction of the electronic device 1000 may be parallel to a third direction DR3 crossing the first direction DR1 and the second direction DR2. Thus, a front surface (or an upper surface) and a rear surface (or a lower surface) of members constituting the electronic device 1000 may be defined on the basis of the third direction DR3.

The first display panel DP1 or the first display portion DA1-F may include a folding region FA which is folded and unfolded, and a plurality of non-folding regions NFA1 and NFA2 spaced apart from each other with the folding region FA therebetween. The second display panel DP2 may overlap any one among the plurality of non-folding regions NFA1 and NFA2. For example, the second display panel DP2 may overlap a first non-folding region NFA1.

A display direction of a first image IM1a which is displayed in a portion of the first display panel DP1, e.g., the first non-folding region NFA1, and a display direction of a second image IM2a which is displayed in the second display panel DP2 may be opposed to each other. For example, the first image IM1a may be displayed in the third direction DR3, and the second image IM2a may be displayed in a fourth direction DR4 which is an opposite direction of the third direction DR3.

In an embodiment of the inventive concept, the folding region FA may be bent with respect to a folding axis extending along a direction parallel to a long side of the electronic device 1000, e.g., a direction parallel to the second direction DR2. In a folded state of the electronic device 1000, the folding region FA has a predetermined curvature and a curvature radius. The electronic device 1000 may be inner-folded so that the first non-folding region NFA1 and a second non-folding region NFA2 face each other and the first display portion DA1-F is not exposed to the outside.

In an embodiment of the inventive concept, the electronic device 1000 may be outer-folded so that the first display portion DA1-F is exposed to the outside. In an embodiment of the inventive concept, the electronic device 1000 may be capable of both being inner-folded or outer-folded in an unfolded state, but an embodiment of the inventive concept is not limited thereto.

FIG. 1A illustrates that one folding region FA is defined in the electronic device 1000 as an example, but embodiments of the inventive concept are not limited thereto. For example, a plurality of folding axes and a plurality of folding regions corresponding to the folding axes may be defined in the electronic device 1000, and the electronic device 1000 may be inner-folded or outer-folded in an unfolded state at each of the plurality of folding regions.

According to an embodiment of the inventive concept, at least one of the first display panel DP1 or the second display panel DP2 may sense an input by the pen PN even though a digitizer is not included. Thus, since a digitizer for sensing the pen PN may be omitted, an increase in thickness, an increase in weight, and deterioration in flexibility of the electronic device 1000 due to addition of a digitizer may not occur. Thus, the second display panel DP2 as well as the first display panel DP1 may be designed to sense the pen PN.

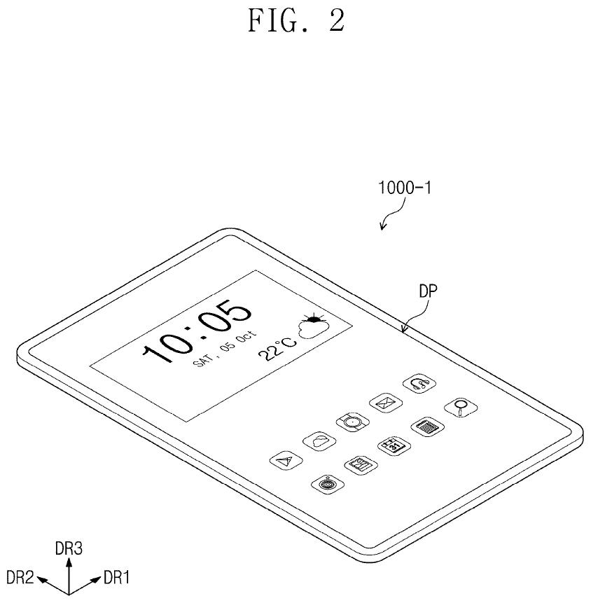

FIG. 2 is a perspective view of an electronic device 1000-1 according to an embodiment of the inventive concept.

FIG. 2 exemplarily illustrates that the electronic device 1000-1 is a mobile phone, and the electronic device 1000-1 may include a display panel DP.

In an embodiment of the inventive concept, the display panel DP may sense inputs applied from the outside. The external input may be a user's input. A user's input may include external inputs in various forms such as a part of a user's body, the pen PN (see FIG. 1A), light, heat, or pressure.

According to an embodiment of the inventive concept, the display panel DP may sense an input by the pen PN even though a digitizer is not included. Thus, since a digitizer for sensing the pen PN may be omitted, an increase in thickness and an increase in weight of the electronic device 1000-1 due to addition of a digitizer may not occur.

FIG. 1A exemplarily illustrates the foldable-type electronic device 1000, and FIG. 2 exemplarily illustrates the bar-type electronic device 1000-1, but embodiments of the inventive concept described below are not limited thereto. For example, descriptions to be made below may be applied to various electronic devices such as a rollable-type electronic device, a slidable-type electronic device, and a stretchable-type electronic device.

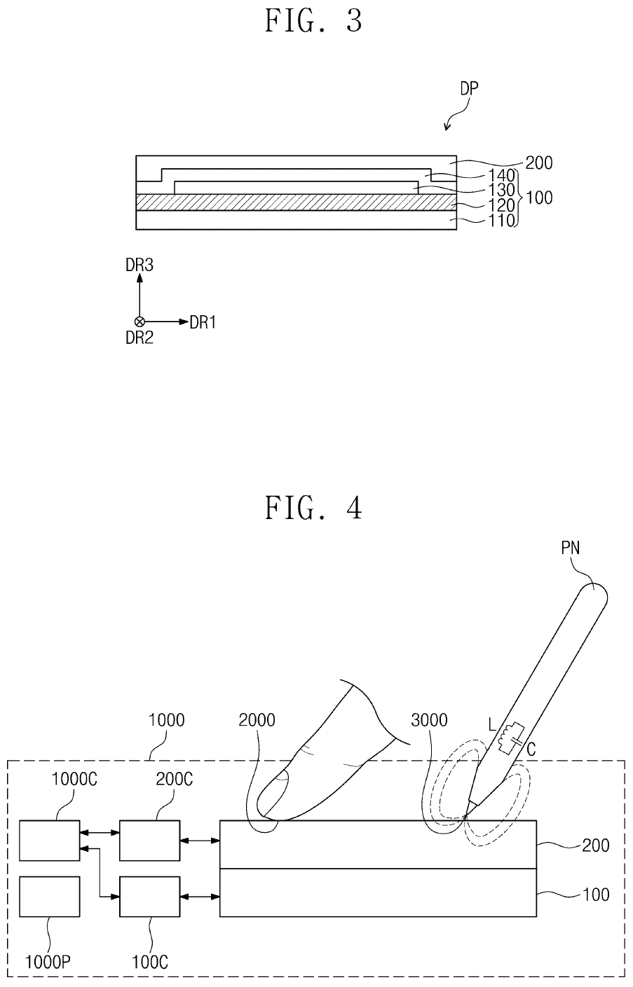

FIG. 3 is a schematic cross-sectional view of a display panel DP according to an embodiment of the inventive concept.

Referring to FIG. 3, the display panel DP may include a display layer 100 and a sensor layer 200.

The display layer 100 may be a component that generates an image. The display layer 100 may be an emissive display layer, and for example, the display layer 100 may be an organic light-emitting display layer, an inorganic light-emitting display layer, an organic-inorganic light-emitting display layer, a quantum dot display layer, a micro-LED display layer, or a nano-LED display layer. The display layer 100 may include a base layer 110, a circuit layer 120, a light-emitting element layer 130, and an encapsulation layer 140.

The base layer 110 may be a member that provides a base surface on which the circuit layer 120 is disposed. The base layer 110 may have a multi-layered structure or a single-layered structure. The base layer 110 may be a glass substrate, a metal substrate, a silicon substrate, a polymer substrate, or the like, but is not limited thereto.

The circuit layer 120 may be disposed on the base layer 110. The circuit layer 120 may include at least one of an insulating layer, a semiconductor pattern, a conductive pattern and a signal line. An insulating layer, a semiconductor layer, and a conductive layer may be formed on the base layer 110 through coating, deposition, or the like, and the insulating layer, the semiconductor layer, and the conductive layer may be selectively patterned through a photolithography process performed multiple times.

The light-emitting element layer 130 may be disposed on the circuit layer 120. The light-emitting element layer 130 may include a light-emitting element. For example, the light-emitting element layer 130 may include an organic light-emitting material, an inorganic light-emitting material, an organic-inorganic light-emitting material, a quantum dot, a quantum rod, a micro-LED, or a nano-LED.

The encapsulation layer 140 may be disposed on the light-emitting element layer 130. The encapsulation layer 140 may protect the light-emitting element layer 130 from moisture, oxygen, and foreign substances such as dust particles.

The sensor layer 200 may be disposed on the display layer 100. The sensor layer 200 may sense an external input applied from the outside. The sensor layer 200 may be an integrated sensor continuously formed in a manufacturing process for the display layer 100, or the sensor layer 200 may be an external sensor attached to the display layer 100. The sensor layer 200 may be referred to as a sensor, an input sensing layer, an input sensing panel or an electronic device for sensing an input coordinate.

According to an embodiment of the inventive concept, the sensor layer 200 may sense both an input from a passive-type input means such as a user's body and an input from an input device that generates a magnetic field having a predetermined resonant frequency. The input device may be referred to as a pen, an input pen, a magnetic pen, a stylus pen, or an electromagnetic resonance pen.

FIG. 4 is a diagram illustrating an operation of an electronic device 1000 according to an embodiment of the inventive concept.

Referring to FIG. 4, the electronic device 1000 may include a display layer 100, a sensor layer 200, a display driver 100C (e.g., a first driver circuit), a sensor driver 200C (e.g., a second driver circuit), a main driver 1000C (e.g., a third driver circuit), and a power circuit 1000P.

The sensor layer 200 may sense a first input 2000 or a second input 3000 applied from the outside. Each of the first input 2000 and the second input 3000 may be from an input means capable of providing a change to capacitance of the sensor layer 200 or an input means capable of causing induced current in the sensor layer 200. For example, the first input 2000 may be from a passive-type input means such as a user's body. The second input 3000 may be an input by a pen PN or an input by a radio frequency identification (RFIC) tag. For example, the pen PN may be a passive-type pen or an active-type pen.

In an embodiment of the inventive concept, the pen PN may be a device which generates a magnetic field having a predetermined resonant frequency. The pen PN may be configured to transmit an output signal based on an electromagnetic resonance method. The pen PN may be referred to as an input device, an input pen, a magnetic pen, a stylus pen, or an electromagnetic resonance pen.

The pen PN may include an RLC resonant circuit, and the RLC resonant circuit may include an inductor L and a capacitor C. In an embodiment of the inventive concept, the RLC resonant circuit may be a variable resonant circuit that varies a resonant frequency. In this case, the inductor L may be a variable inductor and/or the capacitor C may be a variable capacitor, but embodiments of the inventive concept are not limited thereto.

The inductor L generates current due to a magnetic field which is formed in the sensor layer 200. However, an embodiment of the inventive concept is not particularly limited thereto. For example, if the pen PN operates as an active-type, the pen PN may generate current even if the pen PN is not provided with a magnetic field from the outside. The generated current is transmitted to the capacitor C. The capacitor C is charged with current inputted from the inductor L and discharges the charged current to the inductor L. Then, the inductor L may emit a magnetic field having a resonant frequency. Induced current may flow in the sensor layer 200 due to a magnetic field emitted by the pen PN, and the induced current may be transmitted to the sensor driver 200C as a reception signal (or a sensing signal).

The main driver 1000C may control an overall operation of the electronic device 1000. For example, the main driver 1000C may control an operation of the display driver 100C and the sensor driver 200C. The main driver 1000C may include at least one microprocessor, and may further include a graphics controller. The main driver 1000C may be an application processor, a central processing unit, or a main processor.

The display driver 100C may drive the display layer 100. The display driver 100C may receive image data and a control signal from the main driver 1000C. The control signal may include various signals. For example, the control signal may include an input vertical synchronization signal, an input horizontal synchronization signal, a main clock (e.g., a clock signal) and a data enable signal.

The sensor driver 200C may drive the sensor layer 200. The sensor driver 200C may receive a control signal from the main driver 1000C. The control signal may include a clock signal for the sensor driver 200C. In addition, the control signal may further include a mode determination signal that determines a driving mode of the sensor driver 200C and the sensor layer 200.

The sensor driver 200C may be embodied as an integrated circuit (IC) and electrically connected to the sensor layer 200. For example, the sensor driver 200C may be directly mounted in a predetermined region of a display panel or mounted on a separate printed circuit board using a chip-on-film (COF) method and electrically connected to the sensor layer 200.

The sensor driver 200C and the sensor layer 200 may selectively operate in a first mode or a second mode. For example, the first mode may be a mode for sensing a touch input, e.g., the first input 2000. The second mode may be a mode for sensing an input by the pen PN, e.g., the second input 3000. The first mode may be referred to as a touch sensing mode, and the second mode may be referred to as a pen sensing mode.

Switching between the first mode and the second mode may be performed in various ways. For example, the sensor driver 200C and the sensor layer 200 may be driven in the first mode and the second mode in a time-division manner and sense the first input 2000 and the second input 3000. Alternatively, switching between the first mode and the second mode may be caused by a user's selection or a user's specific action, or any one of the first mode or the second mode may be activated or deactivated, or may be switched to the other by activation or deactivation of a specific application. Alternatively, while the sensor driver 200C and the sensor layer 200 are operating alternately in the first mode and the second mode, when the first input 2000 is sensed, the first mode may be maintained, or when the second input 3000 is sensed, the second mode may be maintained.

The sensor driver 200C may calculate coordinate information of an input on the basis of a signal received from the sensor layer 200 and provide a coordinate signal having coordinate information to the main driver 1000C. The main driver 1000C executes an operation corresponding to a user's input on the basis of the coordinate signal. For example, the main driver 1000C may operate the display driver 100C so that a new application image is displayed in the display layer 100.

The power circuit 1000P may include a power management integrated circuit (PMIC). The power circuit 1000P may generate a plurality of driving voltages for driving the display layer 100, the sensor layer 200, the display driver 100C, and the sensor driver 200C. For example, the plurality of driving voltages may include a gate high voltage, a gate low voltage, a first driving voltage (e.g., an ELVSS voltage), a second driving voltage (e.g., an ELVDD voltage), an initialization voltage, etc., but embodiments are not limited thereto.

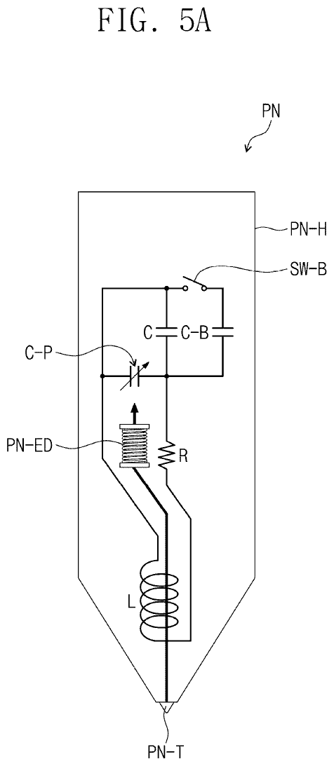

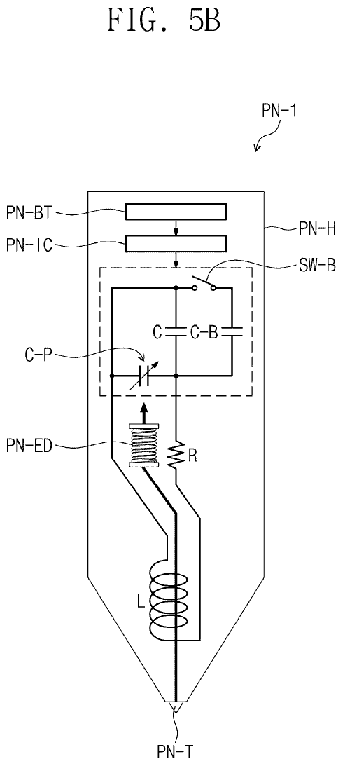

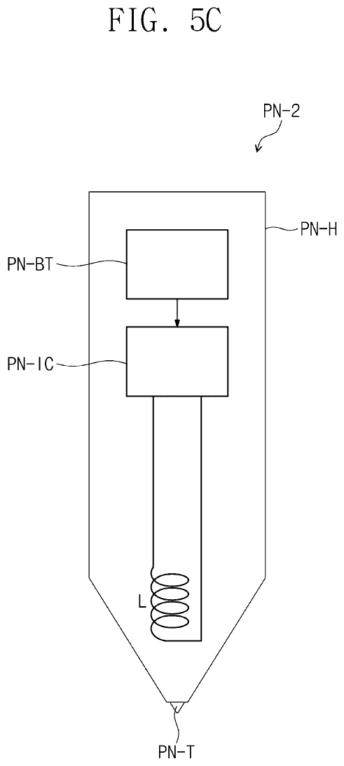

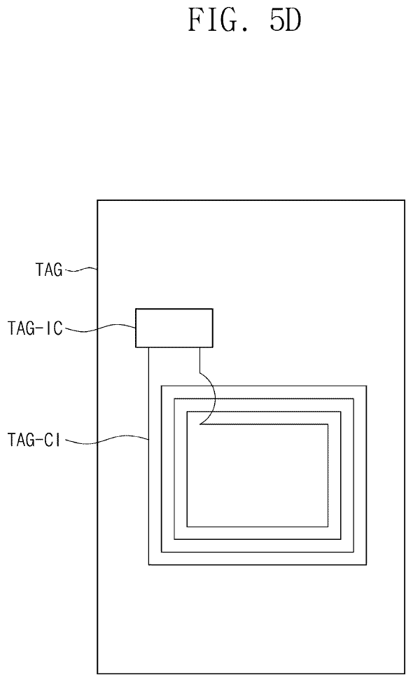

FIG. 5A is a diagram illustrating a pen PN according to an embodiment of the inventive concept.

Referring to FIGS. 4 and 5A, the pen PN may include a housing PN-H, a pen tip PN-T, an inductor L, a capacitor C, a resistance R, an elastic body PN-ED, a pressure capacitor C-P, a switch SW-B, and a button capacitor C-B. The pen PN may not include an active element such as a power, a transistor, or a diode except the switch SW-B connected to the button capacitor C-B. Components included in the pen PN are not limited to the components described above. At least some of the components described above may be omitted, and other components may be added.

In an embodiment of the inventive concept, the pen tip PN-T may include a non-conductive material. The pen tip PN-T may have a structure protruding to the outside of the housing PN-H. The pen tip PN-T may be detachably coupled to the housing PN-H, and may be a replaceable component.

In an embodiment of the inventive concept, the resistor R, the inductor L, and the capacitor C of the RLC resonant circuit may be connected in series. Thus, the pen PN may have a structure having a resonant frequency and selectivity which are characteristics of an RLC series circuit. In this case, a frequency of signals which are provided when the sensor layer 200 is charge driven and are provided to the sensor layer 200 may correspond to a resonant frequency of the pen PN. The capacitor C, the pressure capacitor C-P, and the button capacitor C-B may be connected in parallel. For reference, the button capacitor C-B may be connected to the capacitor C in parallel when the switch SW-B is turned on.

In an embodiment of the inventive concept, according to the switch SW-B being turned on-off, the button capacitor C-B may be electrically connected to or separated from the capacitor C. That is, the pen PN may be provided so as to react to another resonant frequency by turning on-off the switch SW-B. For example, a button may be provided on an outer circumferential surface of the housing PN-H. When the button is pressed, the switch SW-B may be turned on, and the button capacitor C-B may be electrically connected to the capacitor C, thereby increasing a total capacitance of the pen PN.

In an embodiment of the inventive concept, the capacitor C may be provided by cutting a portion of a plurality of capacitors connected in parallel. For example, to achieve a target resonant frequency in a process of manufacturing the pen PN, a portion of the plurality of capacitors may be cut so that the capacitor C of the pen PN may be tuned.

In an embodiment of the inventive concept, when a portion of the pen tip PN-T is inserted into the housing PN-H due to pen pressure, an area size, a distance, or an area size and a distance that forms a capacitance of the pressure capacitor C-P may be changed. Thus, the capacitance of the pressure capacitor C-P may be changed. For example, when pen pressure is applied to the pen PN, the capacitance of the pressure capacitor C-P may increase, and a resonant frequency of the pen PN may decrease according to the increased capacitance. Then, when pen pressure disappears, the capacitance of the pressure capacitor C-P may be restored by the body PN-ED having an elastic characteristic.

FIG. 5B is a diagram illustrating a pen PN-1 according to an embodiment of the inventive concept. For example, the pen PN of FIG. 4 may be implemented by the pen PN-1 of FIG. 5B.

In describing with reference to FIG. 5B, components described with reference to FIG. 5A will be denoted as the same reference numerals or symbols, and description thereof will be omitted.

Referring to FIGS. 4 and 5B, the pen PN-1 may further include a power unit PN-BT and a control unit PN-IC, compared to the pen PN illustrated in FIG. 5A. The power unit PN-BT may include a battery or a high-capacitance capacitor. The control unit PN-IC may be supplied with power from the power unit PN-BT and may adjust a frequency of a signal outputted from the pen PN-1.

According to an embodiment of the inventive concept, the pen PN-1 may operate as an active-type as well as a passive-type since the pen PN-1 may include an RLC resonant circuit, the power unit PN-BT, and the control unit PN-IC. Thus, even if a magnetic field is not provided from the sensor layer 200, the pen PN-1 may emit a magnetic field. Thus, the sensor layer 200 may sense an input by the pen PN-1 that outputs a magnetic field without a charging mode in which a magnetic field is formed.

FIG. 5C is a diagram illustrating a pen PN-2 according to an embodiment of the inventive concept. For example, the pen PN of FIG. 4 may be implemented by the pen PN-1 of FIG. 5C.

Referring to FIGS. 4 and 5C, the pen PN-2 does not include an RLC resonant circuit. For example, the pen PN-2 may include a housing PN-H, a pen tip PN-T, an inductor L, a power unit PN-BT, and a control unit PN-IC (e.g., a control circuit). The power unit PN-BT may include a battery or a high-capacitance capacitor. The control unit PN-IC may be supplied with power from the power unit PN-BT and may adjust a frequency of a signal outputted from the pen PN-2.

According to an embodiment of the inventive concept, the pen PN-2 may operate as an active-type. Thus, even if a magnetic field is not provided from the sensor layer 200, the pen PN-2 may emit a magnetic field.

FIG. 5D is a diagram illustrating an input device TAG according to an embodiment of the inventive concept.

Referring to FIGS. 4 and 5D, the sensor layer 200 may sense an input from an input device TAG. The input device TAG may be an electronic tag, a smart tag or an electronic label. The input device TAG may include a controller TAG-IC (e.g., a controller circuit) and an antenna TAG-CI connected to the controller TAG-IC. The antenna TAG-CI may emit a radio wave having a unique code. The sensor layer 200 may detect the code of the input device TAG.

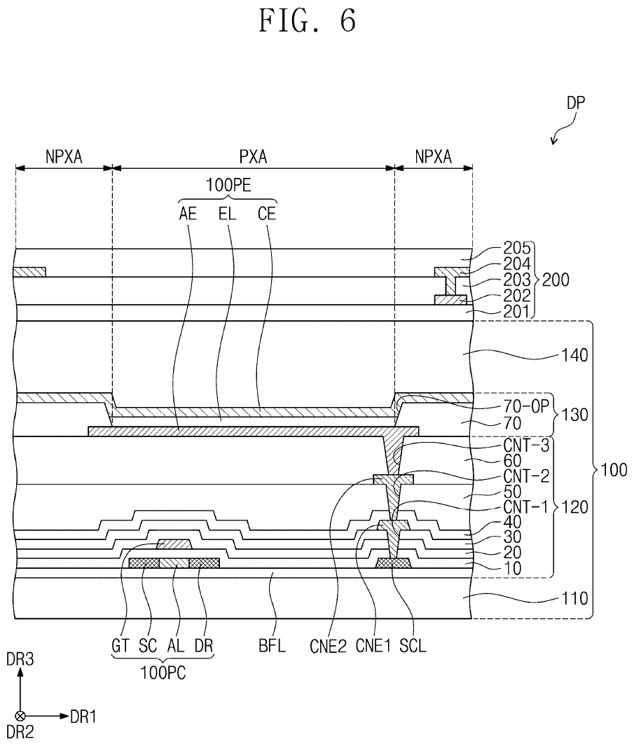

FIG. 6 is a cross-sectional view of a display panel DP according to an embodiment of the inventive concept. FIG. 6 may illustrate an embodiment of the display panel DP shown in FIG. 3.

Referring to FIG. 6, at least one buffer layer BFL is formed on an upper surface of a base layer 110. The buffer layer BFL may increase bonding force between the base layer 110 and a semiconductor pattern. The buffer layer BFL may be formed of multiple layers. Alternatively, a display layer 100 may further include a barrier layer. The buffer layer BFL may include at least one of silicon oxide, silicon nitride, or silicon oxynitride. For example, the buffer layer BFL may have a structure in which a silicon oxide layer and a silicon nitride layer are alternately stacked.

A semiconductor pattern SC, AL, DR, and SCL may be disposed on the buffer layer BFL. The semiconductor pattern SC, AL, DR, and SCL may include polysilicon. However, embodiments of the inventive concept are not limited thereto, and the semiconductor pattern SC, AL, DR, and SCL may include amorphous silicon, low-temperature polycrystalline silicon, or an oxide semiconductor.

FIG. 6 illustrates a partial semiconductor pattern SC, AL, DR, and SCL, but other semiconductor patterns may be further disposed in another region. The semiconductor pattern SC, AL, DR, and SCL may be arranged according to a specific rule across pixels. The semiconductor pattern SC, AL, DR, and SCL may have a different electrical property according to whether the semiconductor pattern is doped or not. The semiconductor pattern SC, AL, DR, and SCL may include a first region SC, DR, and SCL having high conductivity and a second region AL having low conductivity. The first region SC, DR, and SCL may be doped with an N-type dopant or a P-type dopant. The display panel DP may include a transistor 100PC. A P-type transistor may include a doped region doped with a P-type dopant, and an N-type transistor may include a doped region doped with an N-type dopant. For example, the transistor 100PC may be the P-type or the N-type. The second region AL may be an undoped region or a region doped with a lower concentration compared to the first region.

The first region SC, DR, and SCL may have higher conductivity than the second region AL and substantially serve as an electrode or a signal line. The second region AL may substantially correspond to an active region AL (or a channel) of the transistor 100PC. In other words, a portion AL of the semiconductor pattern SC, AL, DR, and SCL may be the active region AL of the transistor 100PC, another portion SC and DR may be a source region SC or a drain region DR of the transistor 100PC, and still another portion SCL may be a connection electrode or a connection signal line SCL.

Each of the pixels may have an equivalent circuit including seven transistors, one capacitor, and a light-emitting element, and an equivalent circuit diagram of the pixel may be changed in various forms. FIG. 6 exemplarily illustrates one transistor 100PC and a light-emitting element 100PE included in the pixel.

The source region SC, the active region AL, and the drain region DR of the transistor 100PC may be formed from the semiconductor pattern SC, AL, DR, and SCL. The source region SC and the drain region DR may extend in opposite directions from the active region AL in a cross-sectional view. FIG. 6 illustrates a portion of the connection signal line SCL formed from the semiconductor pattern SC, AL, DR, and SCL. The connection signal line SCL may be connected to the drain region DR of the transistor 100PC in a plan view.

A first insulating layer 10 may be disposed on the buffer layer BFL. The first insulating layer 10 may overlap the plurality of pixels in common and cover the semiconductor pattern SC, AL, DR, and SCL. The first insulating layer 10 may be an inorganic layer and/or an organic layer and have a single or multi-layered structure. The first insulating layer 10 may include at least one of aluminum oxide, titanium oxide, silicon oxide, silicon nitride, silicon oxynitride, zirconium oxide, or hafnium oxide. In this embodiment, the first insulating layer 10 may be a single-layered silicon oxide layer. An insulating layer of a circuit layer 120 to be described later as well as the first insulating layer 10 may be an inorganic layer and/or an organic layer and have a single- or multi-layered structure. The inorganic layer may include at least one of the materials described above, but embodiments of the inventive concept are not limited thereto.

A gate GT of the transistor 100PC is disposed on the first insulating layer 10. The gate GT may be a portion of a metal pattern. The gate GT overlaps the active region AL. In a process of doping or reducing the semiconductor pattern SC, AL, DR, and SCL, the gate GT may function as a mask.

A second insulating layer 20 may be disposed on the first insulating layer 10 and cover the gate GT. The second insulating layer 20 may overlap the pixels in common. The second insulating layer 20 may be an inorganic layer and/or an organic layer and have a single or multi-layered structure. The second insulating layer 20 may include at least one of silicon oxide, silicon nitride, or silicon oxynitride. In this embodiment, the second insulating layer 20 may have a multi-layered structure including a silicon oxide layer and a silicon nitride layer.

A third insulating layer 30 may be disposed on the second insulating layer 20. The third insulating layer 30 may have a single- or multi-layered structure. For example, the third insulating layer 30 may have a multi-layered structure including a silicon oxide layer and a silicon nitride layer.

A first connection electrode CNE1 may be disposed on the third insulating layer 30. The first connection electrode CNE1 may be connected to the connection signal line SCL via a contact hole CNT-1 passing through the first, second, and third insulating layers 10, 20, and 30.

A fourth insulating layer 40 may be disposed on the third insulating layer 30. The fourth insulating layer 40 may be a single-layered silicon oxide layer. A fifth insulating layer 50 may be disposed on the fourth insulating layer 40. The fifth insulating layer 50 may be an organic layer.

A second connection electrode CNE2 may be disposed on the fifth insulating layer 50. The second connection electrode CNE2 may be connected to the first connection electrode CNE1 via a contact hole CNT-2 passing through the fourth insulating layer 40 and the fifth insulating layer 50.

A sixth insulating layer 60 may be disposed on the fifth insulating layer 50 and cover the second connection electrode CNE2. The sixth insulating layer 60 may be an organic layer.

A light-emitting element layer 130 may be disposed on the circuit layer 120. The light-emitting element layer 130 may include the light-emitting element 100PE. For example, the light-emitting element layer 130 may include an organic light-emitting material, an inorganic light-emitting material, an organic-inorganic light-emitting material, a quantum dot, a quantum rod, a micro-LED, or a nano-LED. Hereinafter, the light-emitting element 100PE will be described as an organic light-emitting element as an example, but embodiments of the inventive concept are not limited thereto.

The light-emitting element 100PE may include a first electrode AE, an emission layer EL, and a second electrode CE.

The first electrode AE may be disposed on the sixth insulating layer 60. The first electrode AE may be connected to the second connection electrode CNE2 via a contact hole CNT-3 passing through the sixth insulating layer 60.

A pixel-defining film 70 may be disposed on the sixth insulating layer 60 and cover a portion of the first electrode AE. An opening 70-OP is defined in the pixel-defining film 70. The opening 70-OP of the pixel-defining film 70 exposes at least a portion of the first electrode AE.

The first display portion DA1-F (see FIG. 1A) may include a light-emitting region PXA and a non-light-emitting region NPXA adjacent to the light-emitting region PXA. The non-light-emitting region NPXA may surround the light-emitting region PXA. In this embodiment, the light-emitting region PXA is defined to correspond to a partial region of the first electrode AE exposed by the opening 70-OP.

The emission layer EL may be disposed on the first electrode AE. The emission layer EL may be disposed in a region corresponding to the opening 70-OP. That is, the emission layer EL may be separately formed in each of the pixels. If the emission layer EL is separately formed in each of the pixels, each emission layer EL may emit at least one of blue light, red light, or green light. However, embodiments of the inventive concept are not limited thereto, and the emission layer EL may be connected to the pixels and included in common in the pixels. In this case, the emission layer EL may provide blue light or may provide white light.

The second electrode CE may be disposed on the emission layer EL. The second electrode CE may have an integrated shape and may be included in common in the plurality of pixels.

In an embodiment of the inventive concept, a hole control layer may be disposed between the first electrode AE and the emission layer EL. The hole control layer may be disposed in common in the light-emitting region PXA and the non-light-emitting region NPXA. The hole control layer may include a hole transport layer and may further include a hole injection layer. An electron control layer may be disposed between the emission layer EL and the second electrode CE. The electron control layer may include an electron transport layer and may further include an electron injection layer. The hole control layer and the electron control layer may be formed in common in the plurality of pixels by using an open mask or an inkjet process.

An encapsulation layer 140 may be disposed on the light-emitting element layer 130. The encapsulation layer 140 may include an inorganic layer, an organic layer, and an inorganic layer which are sequentially stacked, but layers included in the encapsulation layer 140 are not limited thereto. The inorganic layers may protect the light-emitting element layer 130 from moisture and oxygen, and the organic layer may protect the light-emitting element layer 130 from foreign substances such as dust particles. The inorganic layers may include a silicon nitride layer, a silicon oxynitride layer, a silicon oxide layer, a titanium oxide layer or an aluminum oxide layer. The organic layer may include an acrylic organic layer, but is not limited thereto.

A sensor layer 200 may include a base layer 201, a first conductive layer 202, an intermediate insulating layer 203, a second conductive layer 204, and a cover insulating layer 205.

The base layer 201 may be an inorganic layer including at least one of silicon nitride, silicon oxynitride, or silicon oxide. Alternatively, the base layer 201 may be an organic layer including an epoxy resin, an acryl resin, or an imide-based resin. The base layer 201 may have a single-layered structure or a multi-layered structure in which layers are stacked along a third direction DR3.

Each of the first conductive layer 202 and the second conductive layer 204 may have a single-layered structure or a multi-layered structure in which layers are stacked along the third direction DR3.

The first conductive layer 202 and the second conductive layer 204 each having a single-layered structure may each include a metal layer or a transparent conductive layer. The metal layer may include molybdenum, silver, titanium, copper, aluminum, or an alloy thereof. The transparent conductive layer may include a transparent conductive oxide such as indium tin oxide (ITO), indium zinc oxide (IZO), zinc oxide (ZnO), or indium zinc tin oxide (IZTO). In addition, the transparent conductive layer may include a conductive polymer such as poly(3,4-ethylenedioxythiophene) (PEDOT) or a metal nanowire, graphene.

The first conductive layer 202 and the second conductive layer 204 each having a multi-layered structure may each include metal layers. The metal layers may have a three-layered structure of titanium/aluminum/titanium for example. The conductive layer having a multi-layered structure may include at least one metal layer and at least one transparent conductive layer.

In an embodiment of the inventive concept, a thickness of the first conductive layer 202 is greater than or equal to a thickness of the second conductive layer 204. If the thickness of the first conductive layer 202 is greater than the thickness of the second conductive layer 204, a resistance of a component included in the first conductive layer 202 may be reduced. In addition, even if the thickness of the first conductive layer 202 is increased, a pattern of the first conductive layer 202 may be less likely to be viewed due to external light reflection than that of the second conductive layer 204 since the first conductive layer 202 may be disposed lower than the second conductive layer 204.

In an embodiment of the inventive concept, a width of a first mesh line included in the first conductive layer 202 is less than or equal to a width of a second mesh line included in the second conductive layer 204. When a user faces the electronic device 1000 (see FIG. 1A), a probability that the first mesh line will be viewed by the user may be reduced since the first mesh line may have a smaller width than the second mesh line.

At least one of the intermediate insulating layer 203 or the cover insulating layer 205 may include an inorganic film. The inorganic film may include at least one of aluminum oxide, titanium oxide, silicon oxide, silicon nitride, silicon oxynitride, zirconium oxide, or hafnium oxide.

At least one of the intermediate insulating layer 203 or the cover insulating layer 205 may include an organic film. The organic film may include at least one of an acrylic resin, a methacryl-based resin, a polyisoprene-based resin, a vinyl-based resin, an epoxy-based resin, a urethane-based resin, a cellulose-based resin, a siloxane-based resin, a polyimide-based resin, a polyamide-based resin, or a perylene-based resin.

It is described above as an example that the sensor layer 200 includes the first conductive layer 202 and the second conductive layer 204, that is a total of two conductive layers, but embodiments of the inventive concept are not particularly limited thereto. For example, the sensor layer 200 may include three or more conductive layers.

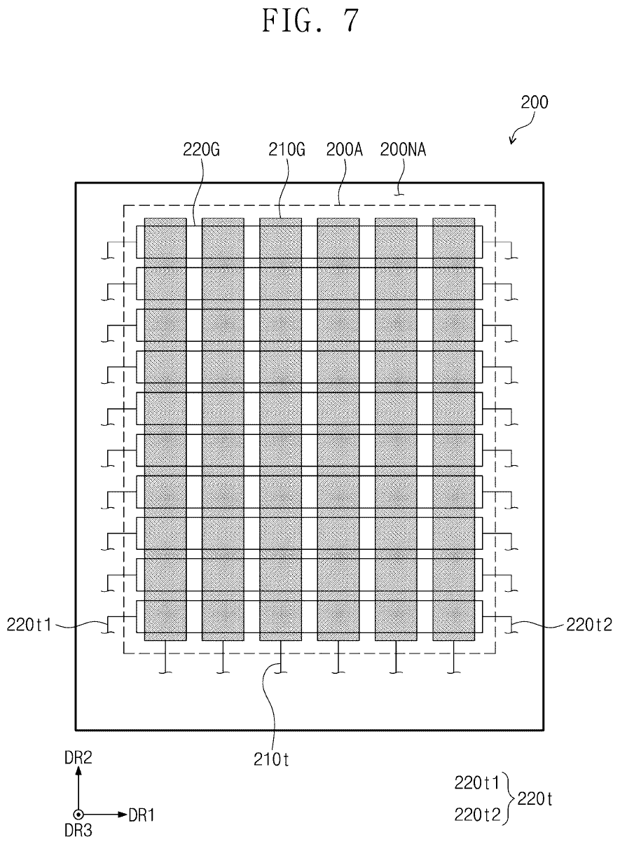

FIG. 7 is a plan view of a sensor layer 200 according to an embodiment of the inventive concept. The sensor layer 200 of FIG. 7 may correspond to the sensor layer 200 of FIG. 6.

Referring to FIG. 7, a sensing region 200A and a peripheral region 200NA adjacent to the sensing region 200A may be defined in the sensor layer 200.

The sensor layer 200 may include a plurality of first electrode groups 210G and a plurality of second electrode groups 220G disposed in the sensing region 200A. Each of the first electrode groups 210G may cross the second electrode groups 220G. Each of the first electrode groups 210G may extend along a second direction DR2, and the first electrode groups 210G may be arranged to be spaced apart from each other in a first direction DR1. Each of the second electrode groups 220G may extend along the first direction DR1, and the second electrode groups 220G may be arranged to be spaced apart from each other in the second direction DR2.

FIG. 7 exemplarily illustrates six first electrode groups 210G and ten second electrode groups 220G, but the number of the first electrode groups 210G and the number of the second electrode groups 220G are not limited thereto.

The sensor layer 200 may further include a plurality of first trace lines 210t and a plurality of second trace lines 220t disposed in the peripheral region 200NA.

In an embodiment of the inventive concept, the first trace lines 210t may be electrically connected, in one-to-one correspondence, to the first electrode groups 210G. That is, one first trace line 210t may be connected to one first electrode group 210G. In an embodiment of the inventive concept, the second trace lines 220t may be electrically connected, in two-to-one correspondence, to the second electrode groups 220G. That is, two second trace lines 220t1 and 220t2 may be electrically connected to one second electrode group 220G. One of the second trace lines 220t1 and 220t2 may be referred to as a first crossing trace line 220t1, and another may be referred to as a second crossing trace line 220t2. Since the second trace lines 220t may be electrically connected, in two-to-one correspondence, to the second electrode groups 220G, the number of the second trace lines 220t may double the number of the second electrode groups 220G.

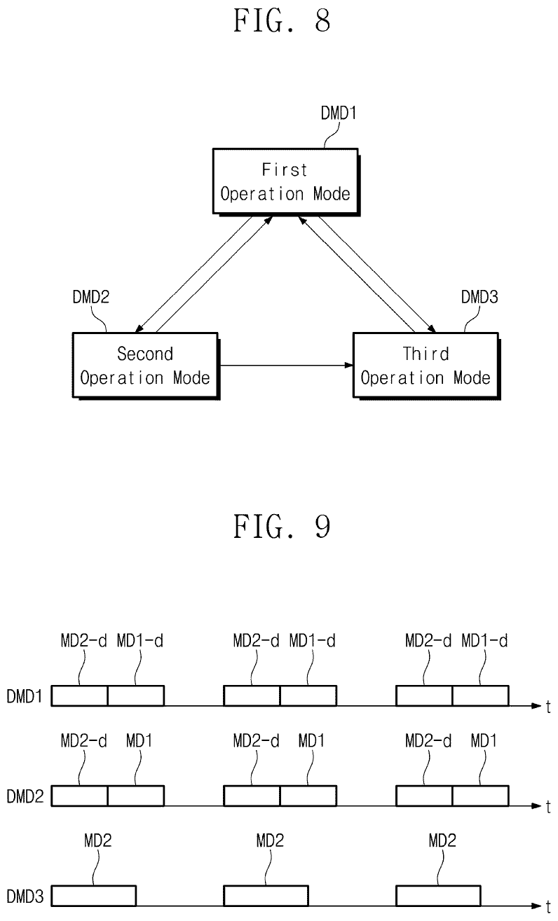

FIG. 8 is a diagram illustrating an operation of the sensor driver 200C (see FIG. 4) according to an embodiment of the inventive concept.

Referring to FIGS. 4 and 8, the sensor driver 200C may be configured to be selectively driven in any one of a first operation mode DMD1, a second operation mode DMD2, or a third operation mode DMD3.

The first operation mode DMD1 may be referred to as a touch and pen waiting mode, the second operation mode DMD2 may be referred to as a touch activating and pen waiting mode, and the third operation mode DMD3 may be referred to as a pen activating mode. The first operation mode DMD1 may be a mode for waiting for the first input 2000 and the second input 3000. The second operation mode DMD2 may be a mode for sensing the first input 2000 and waiting for the second input 3000. The third operation mode DMD3 may be a mode for sensing the second input 3000.

In an embodiment of the inventive concept, the sensor driver 200C may be driven in the first operation mode DMD1 first. When the first input 2000 is sensed in the first operation mode DMD1, the sensor driver 200C may be switched (or changed) to the second operation mode DMD2. Alternatively, when the second input 3000 is sensed in the first operation mode DMD1, the sensor driver 200C may be switched (or changed) to the third operation mode DMD3.

In an embodiment of the inventive concept, when the second input 3000 is sensed in the second operation mode DMD2, the sensor driver 200C may be switched to the third operation mode DMD3. When the first input 2000 is released (or not sensed) in the second operation mode DMD2, the sensor driver 200C may be switched to the first operation mode DMD1. When the second input 3000 is released (or not sensed) in the third operation mode DMD3, the sensor driver 200C may be switched to the first operation mode DMD1.

FIG. 9 is a diagram illustrating an operation of the sensor driver 200C (see FIG. 4) according to an embodiment of the inventive concept.

Referring to FIGS. 4,8, and 9, an operation in the first to third operation modes DMD1, DMD2, and DMD3 is exemplarily illustrated in a time t sequence.

In the first operation mode DMD1, the sensor driver 200C may be repeatedly driven in a second mode MD2-d and a first mode MD1-d. During the second mode MD2-d, the sensor layer 200 may be scan driven so as to detect the second input 3000. During the first mode MD1-d, the sensor layer 200 may be scan driven so as to detect the first input 2000. FIG. 9 exemplarily illustrates that the sensor driver 200C is driven in the second mode MD2-d and then consecutively driven in the first mode MD1-d, but the driving sequence is not limited thereto.

In the second operation mode DMD2, the sensor driver 200C may be repeatedly driven in a second mode MD2-d and a first mode MD1. During the second mode MD2-d, the sensor layer 200 may be scan driven so as to detect the second input 3000. During the first mode MD1, the sensor layer 200 may be scan driven so as to detect a coordinate based on the first input 2000.

In the third operation mode DMD3, the sensor driver 200C may be driven in a second mode MD2. During the second mode MD2, the sensor layer 200 may be scan driven so as to detect a coordinate based on the second input 3000. In the third operation mode DMD3, the sensor driver 200C does not operate in a first mode MD1-d or MD1 until the second input 3000 is released (or not sensed).

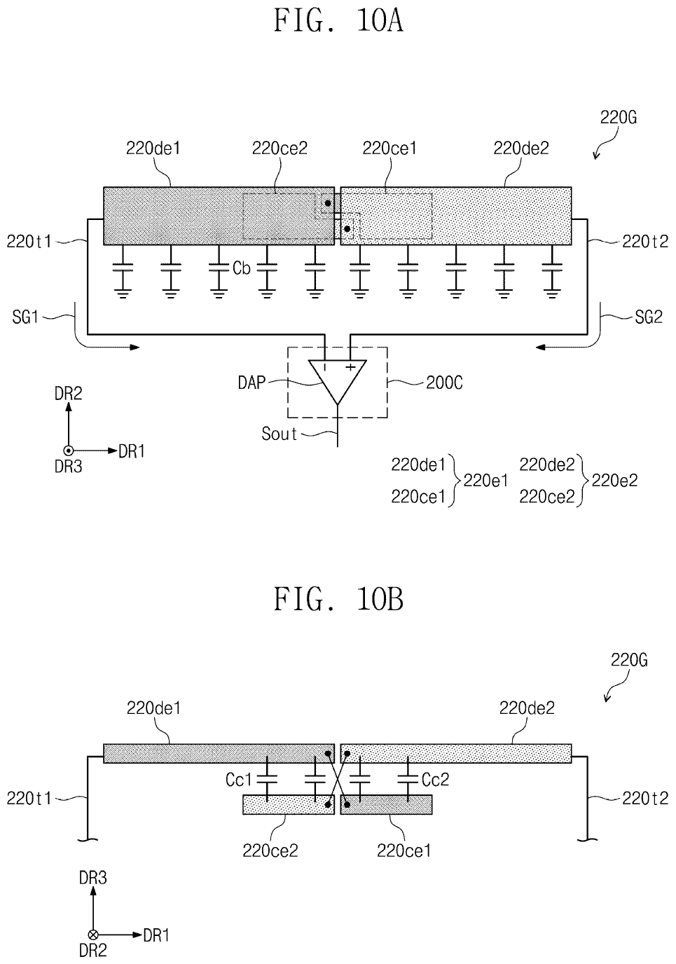

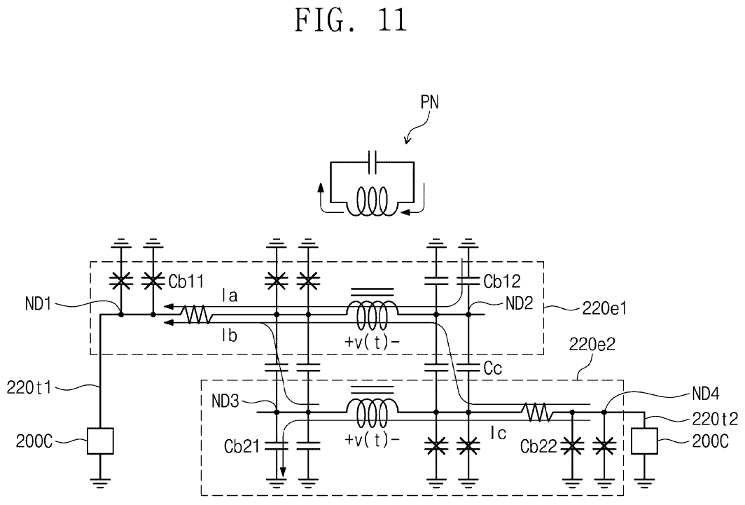

FIG. 10A is a diagram illustrating one electrode group and a portion of a sensor driver according to an embodiment of the inventive concept. For example, FIG. 10A may illustrate one electrode group of the sensor driver 200C. FIG. 10B is a diagram illustrating a portion of the one electrode group according to an embodiment of the inventive concept.

Referring to FIGS. 7, 9, 10A, and 10B, the plurality of second electrode groups 220G may have substantially the same structure. Thus, one second electrode group 220G is described with reference to FIGS. 10A and 10B.

The second electrode group 220G may include a first sensing electrode 220e1 and a second sensing electrode 220e2. The first sensing electrode 220e1 may include a first division electrode 220de1 and a first cross electrode 220ce1, and the second sensing electrode 220e2 may include a second division electrode 220de2 and a second cross electrode 220ce2. The first and second division electrodes 220de1 and 220de2 may be referred to as first and second sub electrodes or first and second electrodes. The first and second cross electrodes 220ce1 and 220ce2 may be referred to as third and fourth sub electrodes or third and fourth electrodes.

The first division electrode 220de1 may extend along a first direction DR1. The second division electrode 220de2 may extend along the first direction DR1. The first division electrode 220de1 and the second division electrode 220de2 may be disposed to be spaced apart from each other in the first direction DR1.

The first cross electrode 220ce1 may be connected to the first division electrode 220de1. In an embodiment, a portion of the first cross electrode 220ce1 overlaps the first division electrode 220de1 and may be connected to the first division electrode 220de1. In an embodiment, another portion of the first cross electrode 220ce1 overlaps the second division electrode 220de2. The second cross electrode 220ce2 may be connected to the second division electrode 220de2. In an embodiment, a portion of the second cross electrode 220ce2 overlaps the second division electrode 220de2 and may be connected to the second division electrode 220de2. In an embodiment, another portion of the second cross electrode 220ce2 overlaps the first division electrode 220de1.

Coupling capacitors Cc1 and Cc2 may be defined in the first sensing electrode 220e1 and the second sensing electrode 220e2. One or more first coupling capacitors Cc1 may be defined between the first division electrode 220de1 and the second cross electrode 220ce2. One or more second coupling capacitors Cc2 may be defined between the second division electrode 220de2 and the first cross electrode 220ce1. FIG. 10B exemplarily illustrates that two first coupling capacitors Cc1 are defined between a first division electrode 220de1 and a second cross electrode 220ce2 and two second coupling capacitors Cc2 are defined between a second division electrode 220de2 and a first cross electrode 220ce1, but embodiments are not limited thereto.

In an embodiment of the inventive concept, the first and second division electrodes 220de1 and 220de2 are disposed on a same layer (e.g., a first layer) or height (e.g., a first height), and the first and second cross electrodes 220ce1 and 220ce2 are disposed on a same layer (e.g., a second layer) or heigh (e.g., a second height). The first and second division electrodes 220de1 and 220de2 may be disposed on a layer different from that on which the first and second cross electrodes 220ce1 and 220ce2 are disposed. For example, the first conductive layer 202 (see FIG. 6) may include the first and second cross electrodes 220ce1 and 220ce2, and the second conductive layer 204 (see FIG. 6) may include the first and second division electrodes 220de1 and 220de2. In this case, the first division electrode 220de1 and the first cross electrode 220ce1 may be electrically connected to each other through a via hole which is formed in the intermediate insulating layer 203 (see FIG. 6), and the second division electrode 220de2 and the second cross electrode 220ce2 may be electrically connected to each other through a via hole which is formed in the intermediate insulating layer 203 (see FIG. 6).

In an embodiment, a length of the first cross electrode 220ce1 in the first direction DR1 is smaller than a length of the second division electrode 220de2 in the first direction DR1. In an embodiment, a length of the second cross electrode 220ce2 in the first direction DR1 is smaller than a length of the first division electrode 220de1 in the first direction DR1.

In an embodiment, a maximum width of the first cross electrode 220ce1 in a second direction DR2 is smaller than a maximum width of the second division electrode 220de2 in the second direction DR2. In an embodiment, a maximum width of the second cross electrode 220ce2 in the second direction DR2 is smaller than a maximum width of the first division electrode 220de1 in the second direction DR2.

The first crossing trace line 220t1 may be electrically connected to the first division electrode 220de1, and the second crossing trace line 220t2 may be electrically connected to the second division electrode 220de2. For example, the first crossing trace line 220t1 may be directly connected to one end of the first division electrode 220de1 among two ends of the first division electrode 220de1, the one end being spaced further apart from the second division electrode 220de2. The second crossing trace line 220t2 may be directly connected to one end of the second division electrode 220de2 among two ends of the second division electrode 220de2, the one end being spaced further apart from the first division electrode 220de1.

The second mode MD2-d or the second mode MD2 may include a pen sensing driving mode. In the pen sensing driving mode, the sensor layer 200 and a sensor driver 200C may sense induced current generated due to a magnetic field which is emitted from a pen PN. In the pen sensing driving mode, the sensor driver 200C may be configured to receive a first signal SG1 from the first division electrode 220de1 and to receive a second signal SG2 from the second division electrode 220de2.

The sensor driver 200C may include a differential amplifier DAP. An inverting terminal of the differential amplifier DAP may be electrically connected to the first division electrode 220de1, and a non-inverting terminal of the differential amplifier DAP may be electrically connected to the second division electrode 220de2. The differential amplifier DAP may amplify a signal proportional to a difference between the first signal SG1 and the second signal SG2 to output an output signal Sout.

When the same noise is included in the first signal SG1 and the second signal SG2, the noise may be removed through the differential amplifier DAP. In an embodiment, a direction of current of the first signal SG1 and a direction of current of the second signal SG2 may be opposed to each other. Thus, when the first signal SG1 and the second signal SG2 are differentiated, a magnitude of a resultant signal may be increased. Thus, a signal-to-noise ratio may increase, thereby providing the driver 200C and the electronic device 1000 (see FIG. 1A) having increased sensing sensitivity.

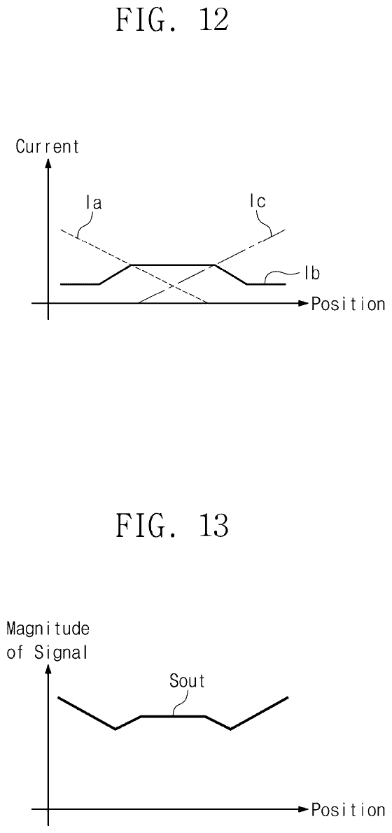

FIG. 11 is an equivalent circuit diagram illustrating a relationship between one electrode group and a pen according to an embodiment of the inventive concept. FIG. 12 is a graph showing a magnitude of current versus a position of a pen with respect to one channel. FIG. 13 is a graph showing a magnitude of an output signal versus a position of a pen with respect to one channel.

Referring to FIGS. 10A to 11, the first sensing electrode 220e1 may be electrically connected to the sensor driver 200C through a first node ND1, and the second sensing electrode 220e2 may be electrically connected to the sensor driver 200C through a fourth node ND4. The first node ND1 may be a left node of the first division electrode 220de1, and the fourth node ND4 may be a right node of the second division electrode 220de2.

FIG. 11 exemplarily illustrates that six first base capacitors Cb11 and Cb12 are defined in the first sensing electrode 220e1, and six second base capacitors Cb21 and Cb22 are defined in the second sensing electrode 220e2. The number of the first base capacitors Cb11 and Cb12 may correspond to the number of sensing patterns included in the first sensing electrode 220e1, and the number of the second base capacitors Cb21 and Cb22 may correspond to the number of sensing patterns included in the second sensing electrode 220e2. The sensing patterns included in the first sensing electrode 220e1 and the sensing patterns included in the second sensing electrode 220e2 will be described later.

If a pen PN is brought close to the first sensing electrode 220e1 and the second sensing electrode 220e2, an electromotive force v(t) may be induced in each of the first sensing electrode 220e1 and the second sensing electrode 220e2 due to a magnetic field generated from the pen PN. FIG. 11 illustrates that the same induced electromotive force v(t) is generated in each of the first sensing electrode 220e1 and the second sensing electrode 220e2 as an example, but different induced electromotive forces v(t) may be generated.

First to third induced current Ia, Ib, and Ic may be generated in the first sensing electrode 220e1 and the second sensing electrode 220e2 due to the induced electromotive force v(t). The first signal SG1 may correspond to a sum of first induced current Ia and second induced current Ib, and the second signal SG2 may correspond to a negative value of a sum of the second induced current Ib and third induced current Ic.

For example, it is assumed that a capacitance of each of the first base capacitors Cb11 and Cb12 and a capacitance of each of the second base capacitors Cb21 and Cb22 are Cb, and it is assumed that a capacitance of each of the first coupling capacitors Cc1 and a capacitance of each of the second coupling capacitors Cc2 are Cc.

The first node ND1 and the fourth node ND4 connected to the sensor driver 200C may be grounded. In addition, a voltage of a second node ND2 corresponding to a right end of the first division electrode 220de1 may be −v(t), and a voltage of a third node ND3 corresponding to a left end of the second division electrode 220de2 may be v(t). Thus, since a voltage of both ends of the first base capacitor Cb11 and the second base capacitor Cb22 may be grounded, current should not flow.

The first induced current Ia according to time may be expressed according to Equation 1.

$$Ia ( t ) = 2 Cb \frac{dv ( t )}{dt} . \qquad [ Equation 1 ]$$

The second induced current Ib according to time may be expressed according to Equation 2.

$$Ib ( t ) \approx 8 Cc \frac{dv ( t )}{dt} . \qquad [ Equation 2 ]$$

The third induced current Ic according to time may be expressed according to Equation 3.

$$Ic ( t ) = 2 Cb \frac{dv ( t )}{dt} . \qquad [ Equation 3 ]$$

Here, dv(t)/dt represents the rate of change of voltage with respect to time, v(t) is voltage as a function of time, −v(t) represents the same as signal as v(t) but with its polarity reversed.

The first signal SG1 may correspond to Ia (t)+Ib (t)+NOISE, and the second signal SG2 may correspond to −Ib(t)−Ic(t)+NOISE.

Referring to FIGS. 11, 12, and 13, as a position of the pen PN moves from the first node ND1 toward the second node ND2, the first induced current Ia may gradually decrease. As a position of the pen PN moves from the fourth node ND4 toward the third node ND3, the third induced current Ic may gradually decrease.

When a position of the pen PN is close to the first node ND1 or to the fourth node ND4 (or, close to the first crossing trace line 220t1 or to the second crossing trace line 220t2), a voltage at both ends of the first coupling capacitors Cc1 or the second coupling capacitors Cc2 may be v(t). When a position of the pen PN is close to the second node ND2 or to the third node ND3 (or, close to the first cross electrode 220ce1 or to the second cross electrode 220ce2), a voltage at both ends of the first coupling capacitors Cc1 or the second coupling capacitors Cc2 may be 2v(t). Accordingly, the second induced current Ib may have a greater value when a position of the pen PN is close to the second node ND2 or close to the third node ND3 than when a position of the pen PN is close to the first node ND1 or close to the fourth node ND4. Thus, even when a position of the pen PN in the first division electrode 220de1 moves away from the first crossing trace line 220t1, an increased second induced current Ib may be additionally generated through the coupling capacitors Cc1 and Cc2. Even when a position of the pen PN in the second division electrode 220de2 moves away from the second crossing trace line 220t2, an increased second induced current Ib may be additionally generated through the coupling capacitors Cc1 and Cc2. Thus, in this embodiment in which the coupling capacitors Cc1 and Cc2 are defined compared to a case in which the coupling capacitors Cc1 and Cc2 are not defined, a relatively increased total induced current may be generated even if a position of the pen PN moves away from the second trace lines 220t. A magnitude (or, a magnitude of a signal) of the total induced current may be secured to be equal to or greater than a predetermined value and sufficient for sensing an input by the pen PN.

When the first signal SG1 and the second signal SG2 are differentiated by the differential amplifier DAP, noise included in the first signal SG1 and in the second signal SG2 may be removed. In addition, since the two signals are differentiated, a magnitude of the output signal Sout may be outputted in a form in which the magnitude is constantly maintained regardless of a position of the pen PN.

Thus, according to an embodiment of the inventive concept, one electrode group includes two division electrodes, where routing directions of the two division electrodes are different from one another. In this case, directions of current of signals received from the two division electrodes may be opposed to each other, and noise generated in the two division electrodes may be substantially the same. If an output signal is generated by differentiating two signals using the differential amplifier DAP, noise may be removed, and a magnitude of the output signal Sout may be increased. Thus, a signal-to-noise ratio may increase, thereby providing the electronic device 1000 (see FIG. 1A) having increased sensing sensitivity.

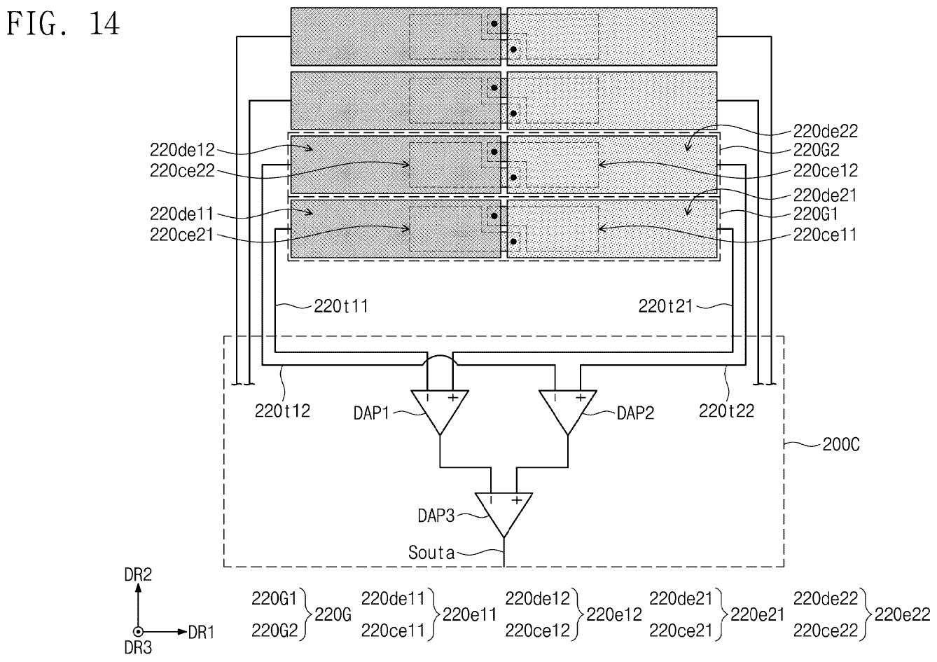

FIG. 14 is a diagram illustrating four electrode groups and a portion of a sensor driver according to an embodiment of the inventive concept.

Referring to FIGS. 7 and 14, a sensor driver 200C may include a first differential amplifier DAP1, a second differential amplifier DAP2, and a third differential amplifier DAP3.

In a pen sensing driving mode, each of the first differential amplifier DAP1 and the second differential amplifier DAP2 may receive signals from the second electrode groups 220G, an inverting terminal of the third differential amplifier DAP3 may receive a signal outputted from the first differential amplifier DAP1, a non-inverting terminal of the third differential amplifier DAP3 may receive a signal outputted from the second differential amplifier DAP2, and the third differential amplifier DAP3 may output an output signal Souta.

The second electrode groups 220G may include a (2-1)-th electrode group 220G1 and a (2-2)-th electrode group 220G2 spaced apart from the (2-1)-th electrode group 220G1 in a second direction DR2.

In the pen sensing driving mode, an inverting terminal of the first differential amplifier DAP1 may be electrically connected to a first sensing electrode 220e11 of the (2-1)-th electrode group 220G1 via a (1-1)-th crossing trace line 220t11, and a non-inverting terminal of the first differential amplifier DAP1 may be electrically connected to a second sensing electrode 220e21 of the (2-1)-th electrode group 220G1 via a (2-1)-th crossing trace line 220t21. That is, in the pen sensing driving mode, the inverting terminal of the first differential amplifier DAP1 may be electrically connected to a first division electrode 220de11 and a first cross electrode 220ce11 of the (2-1)-th electrode group 220G1, and the non-inverting terminal of the first differential amplifier DAP1 may be electrically connected to a second division electrode 220de21 and a second cross electrode 220ce21 of the (2-1)-th electrode group 220G1.

In the pen sensing driving mode, an inverting terminal of the second differential amplifier DAP2 may be electrically connected to a first sensing electrode 220e12 of the (2-2)-th electrode group 220G2 via a (1-2)-th crossing trace line 220t12, and a non-inverting terminal of the second differential amplifier DAP2 may be electrically connected to a second sensing electrode 220e22 of the (2-2)-th electrode group 220G2 via a (2-2)-th crossing trace line 220t22. That is, in the pen sensing driving mode, the inverting terminal of the second differential amplifier DAP2 may be electrically connected to a first division electrode 220de12 and a first cross electrode 220ce12 of the (2-2)-th electrode group 220G2, and the non-inverting terminal of the second differential amplifier DAP2 may be electrically connected to a second division electrode 220de22 and a second cross electrode 220ce22 of the (2-2)-th electrode group 220G2.

In an embodiment of the inventive concept, it is illustrated that the third differential amplifier DAP3 receives signals provided from two second electrode groups 220G1 and 220G2 which are most adjacent to each other in the second direction DR2 as an example, but embodiments of the inventive concept are not limited thereto. For example, the third differential amplifier DAP3 may receive signals provided from two second electrode groups with one or more second electrode groups disposed therebetween.

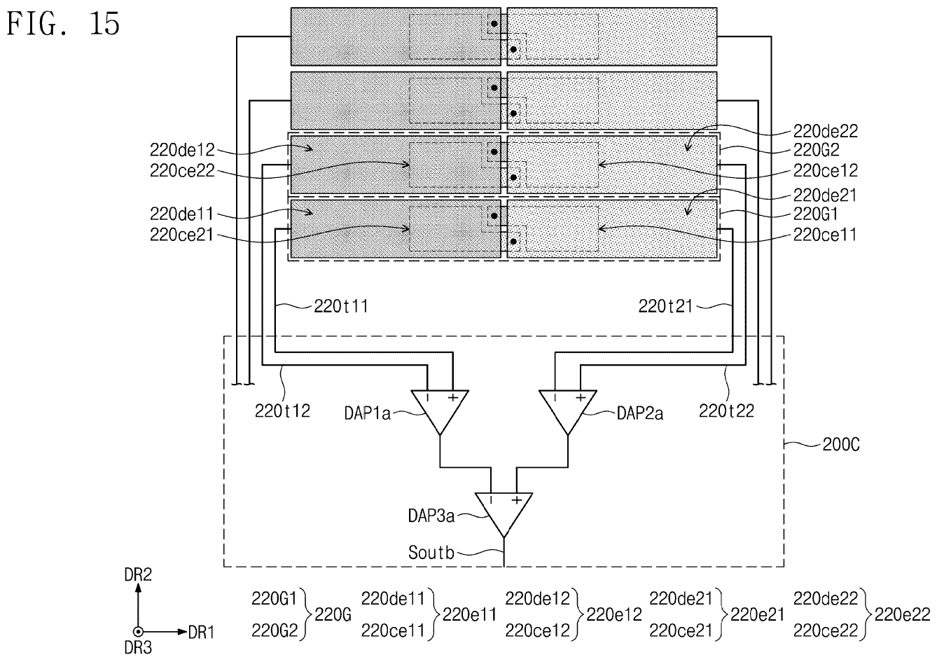

FIG. 15 is a diagram illustrating four electrode groups and a portion of a sensor driver according to an embodiment of the inventive concept.

Referring to FIGS. 7 and 15, a sensor driver 200C may include a first differential amplifier DAP1a, a second differential amplifier DAP2a, and a third differential amplifier DAP3a.

In a pen sensing driving mode, each of the first differential amplifier DAP1a and the second differential amplifier DAP2a may receive signals from the second electrode groups 220G, an inverting terminal of the third differential amplifier DAP3a may receive a signal outputted from the first differential amplifier DAP1a, a non-inverting terminal of the third differential amplifier DAP3a may receive a signal outputted from the second differential amplifier DAP2a, and the third differential amplifier DAP3a may output an output signal Soutb.

The second electrode groups 220G may include a (2-1)-th electrode group 220G1 and a (2-2)-th electrode group 220G2 spaced apart from the (2-1)-th electrode group 220G1 in a second direction DR2.

In the pen sensing driving mode, an inverting terminal of the first differential amplifier DAP1a may be electrically connected to a first sensing electrode 220e12 of the (2-2)-th electrode group 220G2 via a (1-2)-th crossing trace line 220t12, and a non-inverting terminal of the first differential amplifier DAP1a may be electrically connected to a first sensing electrode 220e11 of the (2-1)-th electrode group 220G1 via a (1-1)-th crossing trace line 220t11. That is, in the pen sensing driving mode, the inverting terminal of the first differential amplifier DAP1a may be electrically connected to a first division electrode 220de12 and a first cross electrode 220ce12 of the (2-2)-th electrode group 220G2, and the non-inverting terminal of the first differential amplifier DAP1a may be electrically connected to a first division electrode 220de1l and a first cross electrode 220ce11 of the (2-1)-th electrode group 220G1.

In the pen sensing driving mode, an inverting terminal of the second differential amplifier DAP2a may be electrically connected to a second sensing electrode 220e21 of the (2-1)-th electrode group 220G1 via a (2-1)-th crossing trace line 220t21, and a non-inverting terminal of the second differential amplifier DAP2a may be electrically connected to a second sensing electrode 220e22 of the (2-2)-th electrode group 220G2 via a (2-2)-th crossing trace line 220t22. That is, in the pen sensing driving mode, the inverting terminal of the second differential amplifier DAP2a may be electrically connected to a second division electrode 220de21 and a second cross electrode 220ce21 of the (2-1)-th electrode group 220G1, and the non-inverting terminal of the second differential amplifier DAP2a may be electrically connected to a second division electrode 220de22 and a second cross electrode 220ce22 of the (2-2)-th electrode group 220G2.

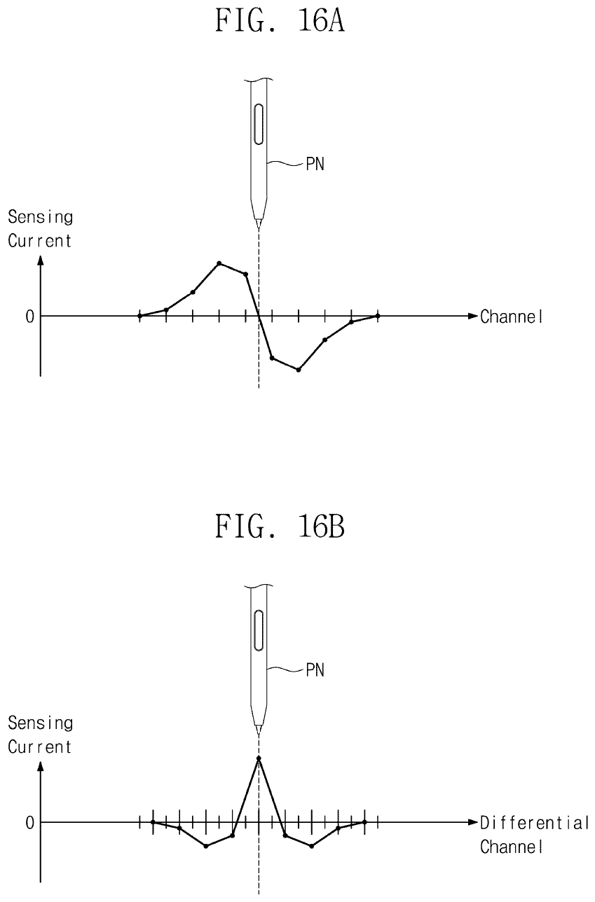

FIG. 16A is a diagram illustrating current sensed in a plurality of electrode groups. FIG. 16B is a diagram illustrating current obtained from a differential pair of a plurality of electrode groups.

Referring to FIGS. 7 and 16A, directions of current sensed from channels spaced apart from each other with a portion in which a pen PN is positioned therebetween may be different. The channels may respectively correspond to the second electrode groups 220G. Thus, directions of current flowing to the channels on a left side and to the channels on a right side with respect to a position of the pen PN may be different. Thus, the sensor driver 200C may sense current flowing in directions different from each other with respect to the position of the pen PN. If the pen PN is positioned right above one electrode group 220G, a signal sensed from the one electrode group 220G may be “0”. For example, as described with reference to FIG. 10A, if a coordinate is calculated using an output signal Sout obtained from one electrode group 220G, a magnitude of a signal received from the one electrode group 220G directly corresponding to the position of the pen PN may be “0”.

Referring to FIGS. 14, 15, and 16B, the output signal Souta or Soutb is a signal obtained from two or more electrode groups 220G1 and 220G2. That is, current may be sensed through differential sensing of channels adjacent to each other or channels spaced apart from each other. In this case, a coordinate of a pen PN may be relatively easily calculated based on a centroid method or a maximum point of a trend line.

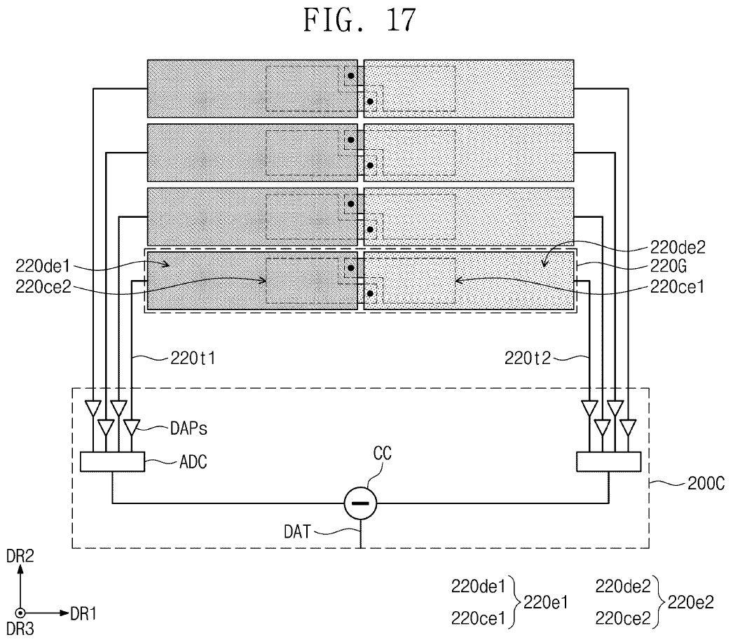

FIG. 17 is a diagram illustrating four electrode groups and a portion of a sensor driver according to an embodiment of the inventive concept.

Referring to FIG. 17, a sensor driver 200C may include a plurality of differential amplifiers DAPs, an analog-to-digital converter ADC, and a difference calculator CC. Some of the differential amplifiers DAPs (e.g., a first group) may be connected to a first ADC and the remainder of the differential amplifiers DAPs (e.g., a second group) may be connected to a second ADC.

The differential amplifiers DAPs may be connected, in one-to-one correspondence, to first sensing electrodes 220e1 and second sensing electrodes 220e2 of second electrode groups 220G. For example, each DAP of the first group may be connected to a corresponding one of the first sensing electrodes 220e1 and each DAP of the second group may be connected to a corresponding one of the second sensing electrodes 220e2. The analog-to-digital converter ADC may receive an analog signal from the differential amplifiers DAPs and convert the received signal into a digital signal. The difference calculator CC may perform a difference operation on data provided from the analog-to-digital converter ADC and output output data DAT in which noise is removed. For example, the first ADC may receive outputs of the first group to generate first data, the second ADC may receive outputs of the second group to generate second data, and the difference calculator CC may perform a difference operation on the first data and the second data to output the output data DAT.

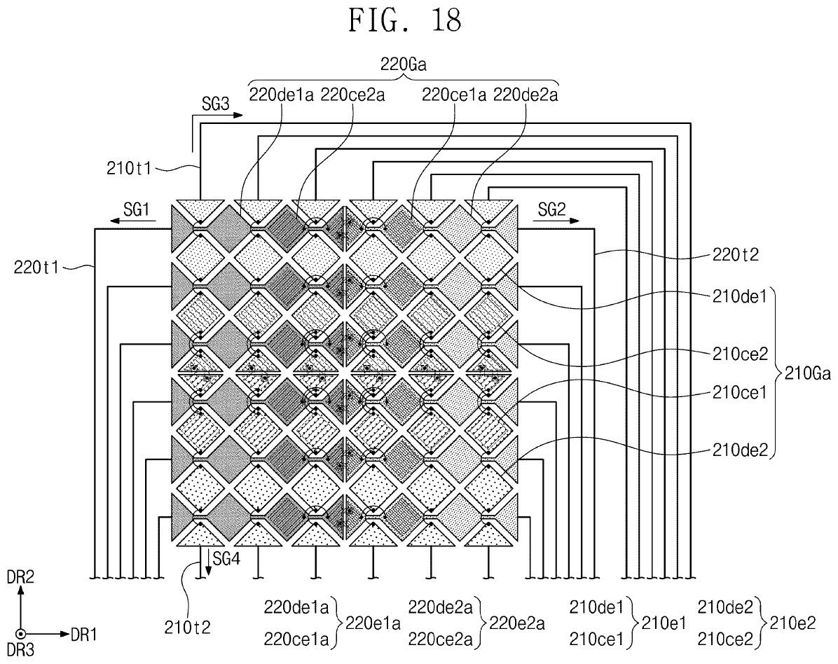

FIG. 18 is a plan view illustrating a portion of a sensor layer according to an embodiment of the inventive concept.

Referring to FIGS. 7, 9, and 18, the sensor layer 200 may include first electrode groups 210Ga and second electrode groups 220Ga. Each of the first electrode groups 210Ga and the second electrode groups 220Ga may include two sensing electrodes. Thus, two trace lines may be electrically connected to each of the first electrode groups 210Ga and the second electrode groups 220Ga. A connection relationship of the sensing electrodes and the trace lines in FIG. 18 is substantially the same as the description made with reference to FIG. 10A and is thus omitted.

Each of the second electrode groups 220Ga may include a first sensing electrode 220e1a and a second sensing electrode 220e2a. The first sensing electrode 220e1a may be electrically connected to a first crossing trace line 220t1, and the second sensing electrode 220e2a may be electrically connected to a second crossing trace line 220t2. The first sensing electrode 220e1a may include a first division electrode 220de1a and a first cross electrode 220ce1a electrically connected to each other, and the second sensing electrode 220e2a may include a second division electrode 220de2a and a second cross electrode 220ce2a electrically connected to each other.

Each of the first electrode groups 210Ga may include a third sensing electrode 210e1 and a fourth sensing electrode 210e2. The third sensing electrode 210e1 may be electrically connected to a third crossing trace line 210t1, and the fourth sensing electrode 210e2 may be electrically connected to a fourth crossing trace line 210t2. The third sensing electrode 210e1 may include a third division electrode 210de1 and a third cross electrode 210ce1 electrically connected to each other, and the fourth sensing electrode 210e2 may include a fourth division electrode 210de2 and a fourth cross electrode 210ce2 electrically connected to each other.

In an embodiment, a length of the first cross electrode 220ce1a in a first direction DR1 is smaller than a length of the second division electrode 220de2a in the first direction DR1. In an embodiment, a length of the second cross electrode 220ce2a in the first direction DR1 is smaller than a length of the first division electrode 220de1a in the first direction DR1.

In an embodiment, a length of the third cross electrode 210ce1 in a second direction DR2 is smaller than a length of the fourth division electrode 210de2 in the second direction DR2. In an embodiment, a length of the fourth cross electrode 210ce2 in the second direction DR2 is smaller than a length of the third division electrode 210de1 in the second direction DR2.

In an embodiment, a maximum width of the first cross electrode 220ce1a in the second direction DR2 is smaller than a maximum width of the second division electrode 220de2a in the second direction DR2. In an embodiment, a maximum width of the second cross electrode 220ce2a in the second direction DR2 is smaller than a maximum with of the first division electrode 220de1a in the second direction DR2.

In an embodiment, a maximum width of the third cross electrode 210ce1 in the first direction DR is smaller than a maximum width of the fourth division electrode 210de2 in the first direction DR1. In an embodiment, a maximum width of the fourth cross electrode 210ce2 in the first direction DR1 is smaller than a maximum width of the third division electrode 210de1 in the first direction DR1.

The second mode MD2-d or the second mode MD2 may include a pen sensing driving mode. In the pen sensing driving mode, the sensor layer 200 and the sensor driver 200C may sense induced current generated due to a magnetic field which is emitted from the pen PN. In the pen sensing driving mode, the sensor driver 200C may be configured to receive a first signal SG1 from the first sensing electrode 220e1a, to receive a second signal SG2 from the second sensing electrode 220e2a, to receive a third signal SG3 from the third sensing electrode 210e1, and to receive a fourth signal SG4 from the fourth sensing electrode 210e2. In the pen sensing driving mode, the sensor driver 200C may process the first to fourth signals SG1, SG2, SG3, and SG4 as described with reference to FIG. 10, FIG. 14, FIG. 15, or FIG. 17.

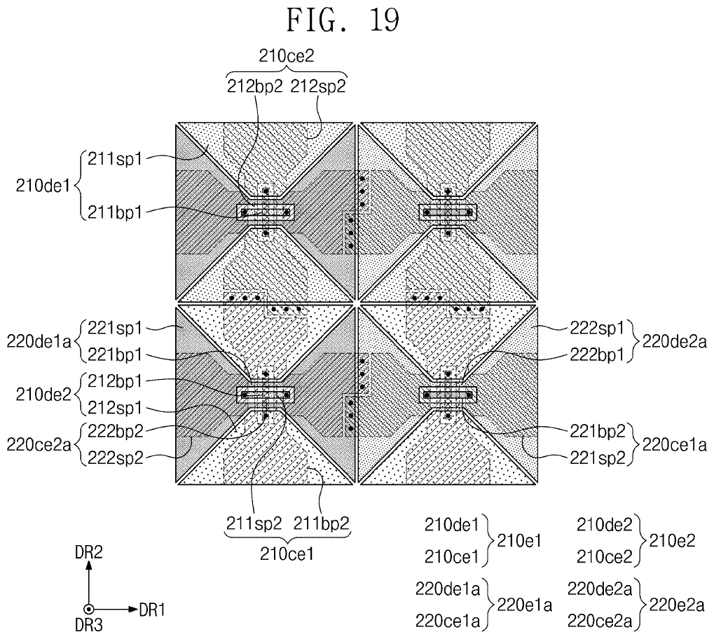

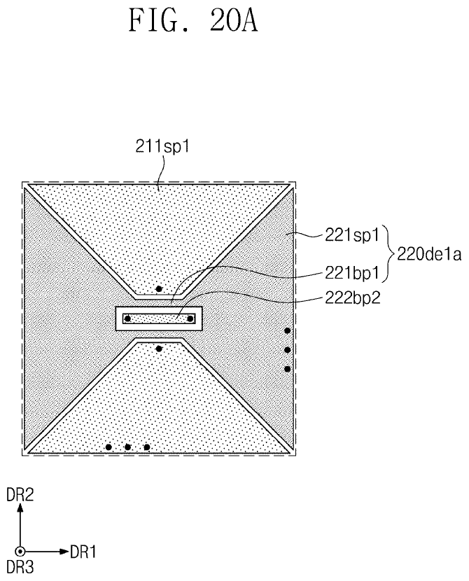

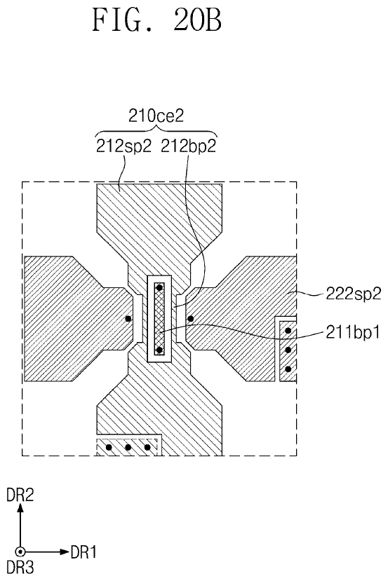

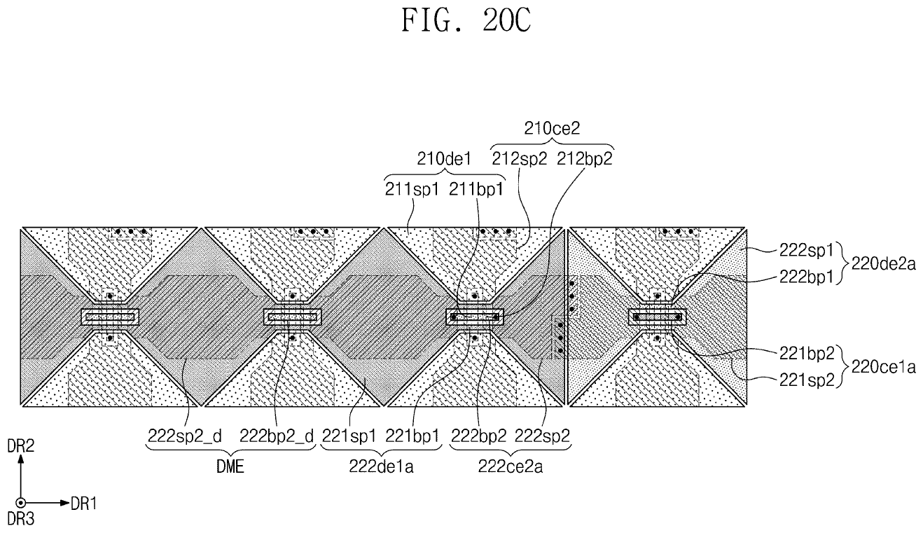

FIG. 19 is a plan view illustrating four sensing units (or four sensors) according to an embodiment of the inventive concept. FIG. 20A is a plan view illustrating a second conductive layer of a sensing unit according to an embodiment of the inventive concept. FIG. 20B is a plan view illustrating a first conductive layer of a sensing unit according to an embodiment of the inventive concept. FIG. 20C is a plan view illustrating four sensing units according to an embodiment of the inventive concept.

Referring to FIGS. 18, 19, 20A, and 20B, each of the first sensing electrodes 220e1a may include a first division electrode 220de1a and a first cross electrode 220ce1a, and each of the second sensing electrodes 220e2a may include a second division electrode 220de2a and a second cross electrode 220ce2a. The first division electrode 220de1a may include (1-1)-th sensing patterns 221sp1 and a (1-1)-th bridge pattern 221bp1. The first cross electrode 220ce1a may include (1-2)-th sensing patterns 221sp2 and a (1-2)-th bridge pattern 221bp2. The second division electrode 220de2a may include (2-1)-th sensing patterns 222sp1 and a (2-1)-th bridge pattern 222bp1. The second cross electrode 220ce2a may include (2-2)-th sensing patterns 222sp2 and a (2-2)-th bridge pattern 222bp2.

Each of the third sensing electrodes 210e1 may include a third division electrode 210de1 and a third cross electrode 210ce1, and each of the fourth sensing electrodes 210e2 may include a fourth division electrode 210de2 and a fourth cross electrode 210ce2. The third division electrode 210de1 may include (3-1)-th sensing patterns 211sp1 and a (3-1)-th bridge pattern 211bp1. The third cross electrode 210ce1 may include (3-2)-th sensing patterns 211sp2 and a (3-2)-th bridge pattern 211bp2. The fourth division electrode 210de2 may include (4-1)-th sensing patterns 212sp1 and a (4-1)-th bridge pattern 212bp1. The fourth cross electrode 210ce2 may include (4-2)-th sensing patterns 212sp2 and a (4-2)-th bridge pattern 212bp2.

In an embodiment, the (1-1)-th sensing patterns 221sp1, the (1-1)-th bridge patterns 221bp1, the (1-2)-th bridge patterns 221bp2, the (2-1)-th sensing patterns 222sp1, the (2-1)-th bridge patterns 222bp1, the (2-2)-th bridge patterns 222bp2, the (3-1)-th sensing patterns 211sp1, and the (4-1)-th sensing patterns 212sp1 are disposed on the same layer (or at a first height), and for example, may be included in the second conductive layer 204 (see FIG. 6). In an embodiment, the (1-2)-th sensing patterns 221sp2, the (2-2)-th sensing patterns 222sp2, the (3-2)-th sensing patterns 211sp2, the (3-1)-th bridge patterns 211bp1, the (3-2)-th bridge patterns 211bp2, the (4-2)-th sensing patterns 212sp2, the (4-1)-th bridge patterns 212bp1, and the (4-2)-th bridge patterns 212bp2 are disposed on the same layer (or at a second height), and for example, may be included in the first conductive layer 202 (see FIG. 6).

The (1-1)-th sensing patterns 221sp1 may be spaced apart from each other in a first direction DR1. The (1-1)-th sensing patterns 221sp1 spaced apart from each other in the first direction DR1 may be electrically connected to each other by the (1-1)-th bridge pattern 221bp1. In an embodiment of the inventive concept, the (1-1)-th sensing patterns 221sp1 spaced apart from each other in the first direction DR1 and the (1-1)-th bridge pattern 221bp1 connecting the (1-1)-th sensing patterns 221sp1 have an integrated shape, and the (1-1)-th bridge pattern 221bp1 may be referred to as a first connection pattern, a first intermediate pattern, or a first extension pattern.

The (2-1)-th sensing patterns 222sp1 may be spaced apart from each other in the first direction DR1. The (2-1)-th sensing patterns 222sp1 spaced apart from each other in the first direction DR1 may be electrically connected to each other by the (2-1)-th bridge pattern 222bp1. In an embodiment of the inventive concept, the (2-1)-th sensing patterns 222sp1 spaced apart from each other in the first direction DR1 and the (2-1)-th bridge pattern 222bp1 connecting the (2-1)-th sensing patterns 222sp1 have an integrated shape, and the (2-1)-th bridge pattern 222bp1 may be referred to as a second connection pattern, a second intermediate pattern, or a second extension pattern.

The (3-1)-th sensing patterns 211sp1 may be spaced apart from each other in a second direction DR2. The (3-1)-th sensing patterns 211sp1 spaced apart from each other in the second direction DR2 may be electrically connected to each other by the (3-1)-th bridge pattern 211bp1. In an embodiment of the inventive concept, the (3-1)-th sensing patterns 211sp1 spaced apart from each other in the second direction DR2 and the (3-1)-th bridge pattern 211bp1 connecting the (3-1)-th sensing patterns 211sp1 may be disposed on different layers and connected through a via hole defined in the intermediate insulating layer 203 (see FIG. 6).

The (4-1)-th sensing patterns 212sp1 may be spaced apart from each other in the second direction DR2. The (4-1)-th sensing patterns 212sp1 spaced apart from each other in the second direction DR2 may be electrically connected to each other by the (4-1)-th bridge pattern 212bp1. In an embodiment of the inventive concept, the (4-1)-th sensing patterns 212sp1 and the (4-1)-th bridge pattern 212bp1 connecting the (4-1)-th sensing patterns 212sp1 are disposed on different layers and connected through a via hole defined in the intermediate insulating layer 203 (see FIG. 6).

The four sensing units illustrated in FIG. 19 may be repeatedly arranged along the first direction DR1 and the second direction DR2. FIG. 19 exemplarily illustrates a portion in which the division electrodes 220de1a, 220de2a, 210de1, and 210de2 and the cross electrodes 220ce1a, 220ce2a, 210ce1, and 210ce2 are disposed to overlap each other.

The first cross electrode 220ce1a may be electrically connected to the first division electrode 220de1a and disposed to overlap the second division electrode 220de2a. The second cross electrode 220ce2a may be electrically connected to the second division electrode 220de2a and disposed to overlap the first division electrode 220de1a. The third cross electrode 210ce1 may be electrically connected to the third division electrode 210de1 and disposed to overlap the fourth division electrode 210de2. The fourth cross electrode 210ce2 may be electrically connected to the fourth division electrode and disposed to overlap the third division electrode 210de1.

The (1-2)-th sensing patterns 221sp2 may be spaced apart from each other in the first direction DR1. The (1-2)-th sensing patterns 221sp2 spaced apart from each other in the first direction DR1 may be electrically connected to each other by the (1-2)-th bridge pattern 221bp2. In an embodiment of the inventive concept, the (1-2)-th sensing patterns 221sp2 spaced apart from each other in the first direction DR1 and the (1-2)-th bridge pattern 221bp2 connecting the (1-2)-th sensing patterns 221sp2 are disposed on different layers and connected through a via hole defined in the intermediate insulating layer 203 (see FIG. 6).

The (2-2)-th sensing patterns 222sp2 may be spaced apart from each other in the first direction DR1. The (2-2)-th sensing patterns 222sp2 spaced apart from each other in the first direction DR1 may be electrically connected to each other by the (2-2)-th bridge pattern 222bp2. In an embodiment of the inventive concept, the (2-2)-th sensing patterns 222sp2 spaced apart from each other in the first direction DR1 and the (2-2)-th bridge pattern 222bp2 connecting the (2-2)-th sensing patterns 222sp2 are disposed on different layers and connected through a via hole defined in the intermediate insulating layer 203 (see FIG. 6).

The (3-2)-th sensing patterns 221sp2 may be spaced apart from each other in the second direction DR2. The (3-2)-th sensing patterns 211sp2 spaced apart from each other in the second direction DR2 may be electrically connected to each other by the (3-2)-th bridge pattern 211bp2. In an embodiment of the inventive concept, the (3-2)-th sensing patterns 211sp2 spaced apart from each other in the second direction DR2 and the (3-2)-th bridge pattern 211bp2 connecting the (3-2)-th sensing patterns 211sp2 have an integrated shape, and the (3-2)-th bridge pattern 211bp2 may be referred to as a third connection pattern, a third intermediate pattern, or a third extension pattern.

The (4-2)-th sensing patterns 212sp2 may be spaced apart from each other in the second direction DR2. The (4-2)-th sensing patterns 212sp2 spaced apart from each other in the second direction DR2 may be electrically connected to each other by the (4-2)-th bridge pattern 212bp2. In an embodiment of the inventive concept, the (4-2)-th sensing patterns 212sp2 spaced apart from each other in the second direction DR2 and the (4-2)-th bridge pattern 212bp2 connecting the (4-2)-th sensing patterns 212sp2 have an integrated shape, and the (4-2)-th bridge pattern 212bp2 may be referred to as a fourth connection pattern, a fourth intermediate pattern, or a fourth extension pattern.

The (1-1)-th sensing pattern 221sp1 of the first division electrode 220de1a and the (1-2)-th sensing pattern 221sp2 of the first cross electrode 220ce1a included in one second electrode group 220Ga may be connected through a via hole defined in the intermediate insulating layer 203 (see FIG. 6). The (2-1)-th sensing pattern 222sp1 of the second division electrode 220de2a and the (2-2)-th sensing pattern 222sp2 of the second cross electrode 220ce2a included in one second electrode group 220Ga may be connected through a via hole defined in the intermediate insulating layer 203 (see FIG. 6).

The (3-1)-th sensing pattern 221sp1 of the third division electrode 210de1 and the (3-2)-th sensing pattern 211sp2 of the third cross electrode 210ce1 included in one first electrode group 210Ga may be connected through a via hole defined in the intermediate insulating layer 203 (see FIG. 6). The (4-1)-th sensing pattern 212sp1 of the fourth division electrode 210de2 and the (4-2)-th sensing pattern 212sp2 of the fourth cross electrode 210ce2 may be connected through a via hole defined in the intermediate insulating layer 203 (see FIG. 6).

Referring to FIG. 20C, the sensor layer 200 according to an embodiment of the inventive concept may further include dummy electrodes DME. The dummy electrodes DME may include first dummy patterns 222sp2_d and second dummy patterns 222bp2_d. In an embodiment, the first dummy patterns 222sp2_d are disposed on the same layer (or at the same height) as that on which the (2-2)-th sensing patterns 222sp2 are disposed and are included in the second conductive layer 204 (see FIG. 6). In an embodiment, the second dummy patterns 222bp2_d are disposed on the same layer (or at the same height) as that on which the (2-2)-th bridge patterns 222bp2 are disposed and are included in the first conductive layer 202 (see FIG. 6).

The first dummy patterns 222sp2_d may be spaced apart from the (2-2)-th sensing patterns 222sp2 in a first direction DR1. The first dummy patterns 222sp2_d may be arranged to be spaced apart from each other in the first direction DR1. The second dummy patterns 222bp2_d may be disposed between the first dummy patterns 222sp2_d spaced apart from each other in the first direction DR1 in a plan view. In an embodiment, the second dummy patterns 222bp2_d is not electrically connected to the first dummy patterns 222sp2_d. Thus, the first dummy patterns 222sp2_d spaced apart from each other in the first direction DR1 are not electrically connected to each other. Each of the first dummy patterns 222sp2_d and the second dummy patterns 222bp2_d may be a floating electrode.

In an embodiment, the first dummy patterns 222sp2_d and the (2-2)-th sensing patterns 222sp2 have the same or substantially the same shape. In an embodiment, the second dummy patterns 222bp2_d and the (2-2)-th bridge patterns 222bp2 have the same or substantially the same shape. Since the first dummy patterns 222sp2_d may be disposed in empty space of the second conductive layer 204 (see FIG. 6) and the second dummy patterns 222bp2_d may be disposed in empty space of the first conductive layer 202 (see FIG. 6), a probability that specific patterns will be viewed due to external light reflection may be reduced. That is, the electronic device 1000 (see FIG. 1A) that makes it possible to suppress visibility deterioration due to external light reflection may be provided.

FIG. 20C exemplarily illustrates only the first dummy patterns 222sp2_d overlapping the (1-1)-th sensing patterns 221sp1 and the second dummy patterns 222bp2_d disposed therebetween in a plan view, but in an embodiment of the inventive concept, first dummy patterns overlapping the (2-1)-th sensing patterns 222sp1, the (3-1)-th sensing patterns 211sp1, or the (4-1)-th sensing patterns 212sp1 and second dummy patterns disposed therebetween may be further included. Thus, referring to FIGS. 20A and 20C, the first dummy patterns 222sp2_d may include patterns having the same shape as that of at least a portion among the (1-2)-th sensing patterns 221sp2, the (2-2)-th sensing patterns 222sp2, the (3-2)-th sensing patterns 211sp2, and the (4-2)-th sensing patterns 233sp2, and the second dummy patterns 222bp2_d may include patterns having the same shape as that of at least a portion among the (1-2)-th bridge pattern 221bp2, the (2-2)-th bridge pattern 222bp2, the (3-2)-th bridge pattern 211bp2, and the (4-2)-th bridge pattern 212bp2.

In an embodiment, patterns illustrated in FIGS. 19 to 20C each have a mesh structure. The mesh structures may each include a plurality of mesh lines. The plurality of mesh lines may each have a straight-lined shape extending in a predetermined direction and may be connected to each other. However, this is merely an example. For example, at least a portion of each of the plurality of mesh lines may have a curved shape.

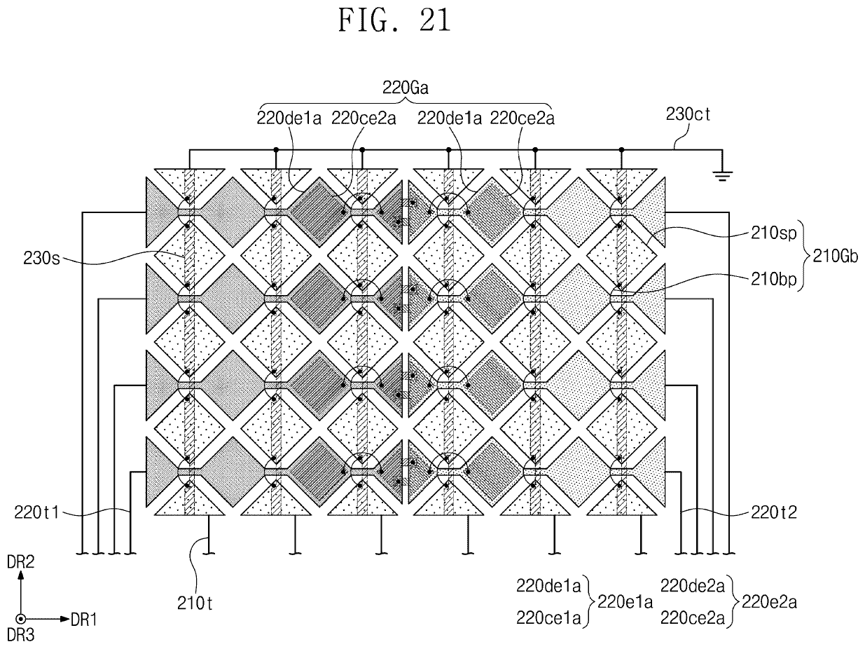

FIG. 21 is a plan view illustrating a portion of a sensor layer according to an embodiment of the inventive concept.

Referring to FIGS. 7 and 21, the sensor layer 200 may further include a plurality of auxiliary electrodes 230s respectively overlapping first electrode groups 210Gb. In addition, a connection trace line 230ct connecting the auxiliary electrodes 230s of the sensor layer 200 to each other may be further included.

In an embodiment, the connection trace line 230ct and first trace lines 210t are spaced apart from each other with the first electrode groups 210Gb and the auxiliary electrodes 230s therebetween. That is, in an embodiment, a routing direction of the first electrode groups 210Gb and a routing direction of the auxiliary electrode 230s are different.

Each of the first electrode groups 210Gb may include third sensing patterns 210sp and third bridge patterns 210bp. The third sensing patterns 210sp may be spaced apart from each other in a second direction DR2. The third sensing patterns 210sp spaced apart from each other in the second direction DR2 may be electrically connected to each other by the third bridge pattern 210bp.

According to an embodiment of the inventive concept, each of first division electrodes 220de1 and second division electrodes 220de2 cross one first electrode group 210Gb and one auxiliary electrode 230s. That is, one first division electrode 220de1 may cross one first electrode group 210Gb and one auxiliary electrode 230s, and one second division electrode 220de2 may cross another first electrode group 210Gb and another auxiliary electrode 230s.

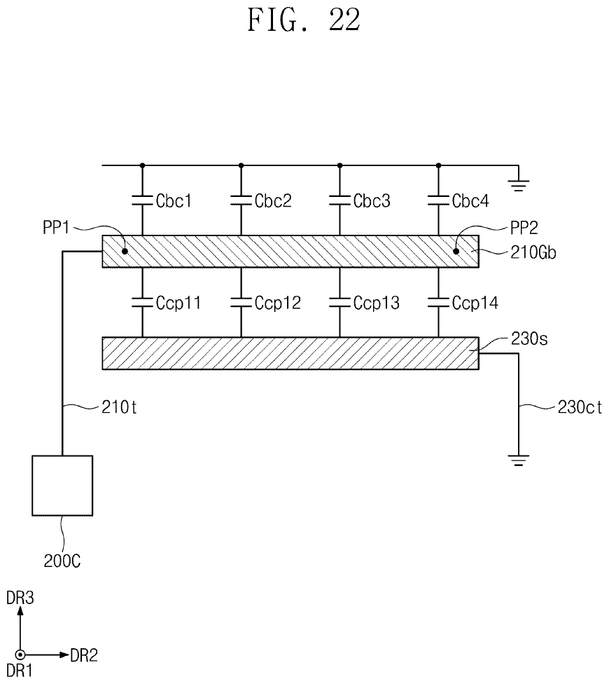

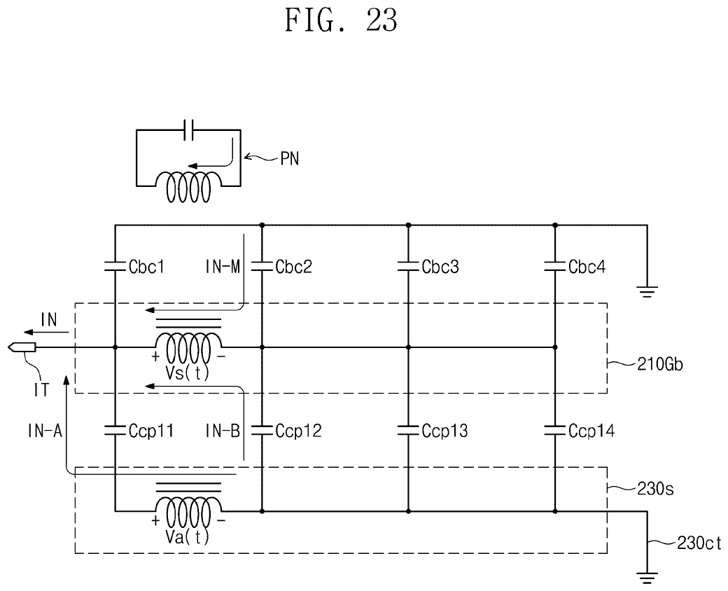

FIG. 22 is a schematic diagram illustrating one channel according to an embodiment of the inventive concept. FIG. 23 is an equivalent circuit diagram illustrating a relationship between one channel and a pen according to an embodiment of the inventive concept.

Referring to FIGS. 21, 22, and 23, one first electrode group 210Gb and one auxiliary electrode 230s are illustrated. In an embodiment, the first electrode group 210Gb and the auxiliary electrode 230s overlap each other when viewed in a third direction DR3.

In an embodiment, one end of the auxiliary electrode 230s is floated, and another end of the auxiliary electrode 230s is grounded. For example, the other end of the auxiliary electrode 230s may be electrically connected to the connection trace line 230ct, and the connection trace line 230ct may be grounded. However, embodiments of the inventive concept are not limited thereto. For example, the connection trace line 230ct may be grounded through a bias capacitor.

Capacitors Cbc1, Cbc2, Cbc3, and Cbc4 may be defined in the first electrode group 210Gb. The capacitors Cbc1, Cbc2, Cbc3, and Cbc4 may be referred to as a parasitic capacitor or a base capacitor. According to an embodiment of the inventive concept, the capacitors Cbc1, Cbc2, Cbc3, and Cbc4 may also be used for increasing a magnitude of a signal.

If a pen PN is close to the first electrode group 210Gb, due to a magnetic field generated from the pen PN, first electromotive force Vs (t) may be induced in the first electrode group 210Gb and second electromotive force Va (t) may be induced in the auxiliary electrode 230s. First induced current IN-M and third induced current IN-B may be generated due to the first induced electromotive force Vs (t), and second induced current IN-A may be generated due to the second induced electromotive force Va (t). Thus, total induced current IN inputted to an input terminal IT may correspond to a sum of the first to third induced current IN-M, IN-A, and IN-B.

For example, it is assumed that a capacitance of each of the capacitors Cbc1, Cbc2, Cbc3, and Cbc4 is Cb, and it is assumed that a capacitance of each of first coupling capacitors Ccp11, Ccp12, Ccp13, and Ccp14 is Cc.

The first induced current IN-M according to time may be expressed according to Equation 4.

$$3 Cb \frac{dVs ( t )}{dt} . \qquad [ Equation 4 ]$$

The second induced current IN-A according to time may be expressed according to Equation 5.

$$Cc \frac{dVa ( t )}{dt} . \qquad [ Equation 5 ]$$

The third induced current IN-B according to time may be expressed according to Equation 6.

$$3 Cc \frac{dVs ( t )}{dt} . \qquad [ Equation 6 ]$$

Here dVs (t)/dt represents the rate of change of the first electromotive force with respect to time and dVa (t)/dt represents the rate of change of the second electromotive force with respect to time.

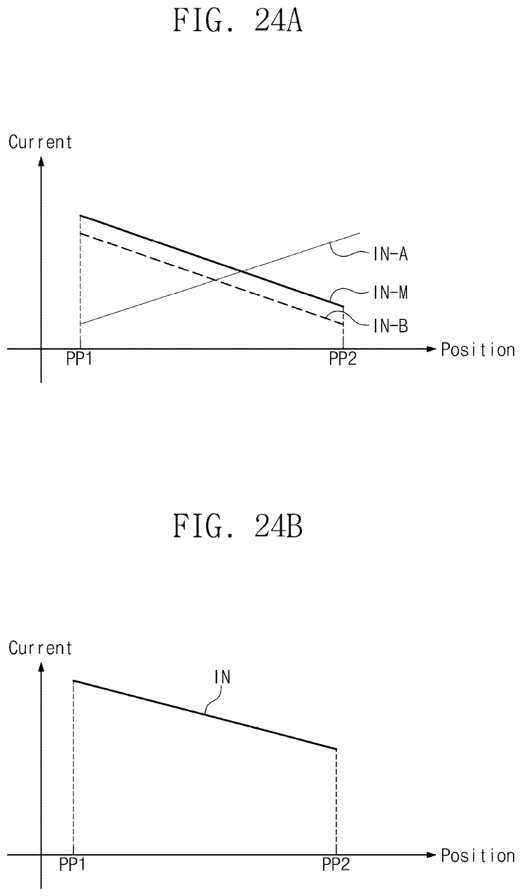

FIG. 24A is a graph showing a magnitude of current versus a position of a pen with respect to one channel. FIG. 24B is a graph showing a magnitude of a signal versus a position of a pen with respect to one channel.

Referring to FIGS. 22, 23, and 24A, since voltage at both ends of capacitors between the input terminal IT and a position of the pen PN among the capacitors Cbc1, Cbc2, Cbc3, and Cbc4 may be grounded, current may not flow. Thus, if the position of the pen PN moves from a first point PP1 to a second point PP2, the first induced current IN-M may gradually decrease. In addition, the second induced current IN-A may gradually increase, and the third induced current IN-B may gradually decrease.

Referring to FIGS. 22, 23, and 24B, if the position of the pen PN moves from a first point PP1 to a second point PP2, the total induced current IN may gradually decrease. However, as described above, the total induced current IN may correspond to a sum of the first to third induced current IN-M, IN-A, and IN-B, and a magnitude of the total induced current IN at the second point PP2 may be secured to be equal to or greater than a predetermined value.

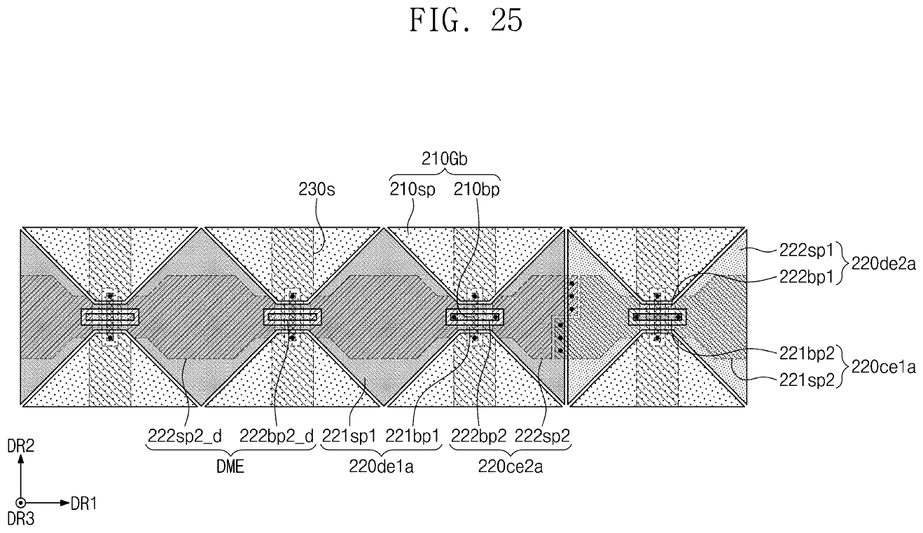

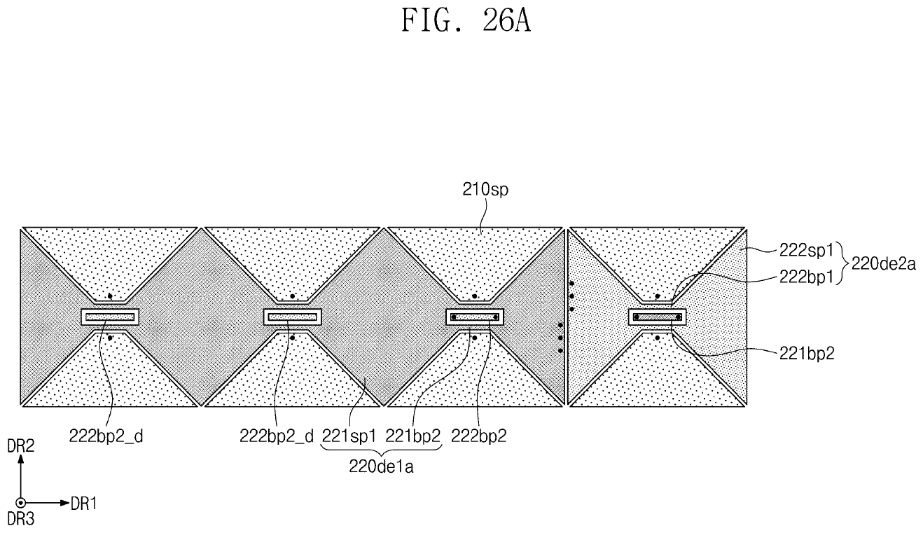

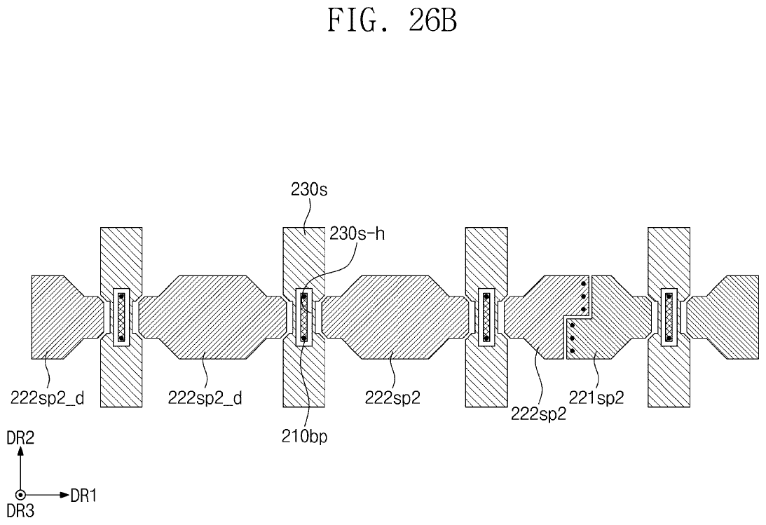

FIG. 25 is a plan view illustrating four sensing units according to an embodiment of the inventive concept. FIG. 26A is a plan view illustrating a second conductive layer of four sensing units according to an embodiment of the inventive concept. FIG. 26B is a plan view illustrating a first conductive layer of four sensing units according to an embodiment of the inventive concept.

Referring to FIGS. 21, 25, 26A, and 26B, each of the second electrode groups 220Ga may include a first division electrode 220de1a, a second division electrode 220de2a, a first cross electrode 220ce1a, and a second cross electrode 220ce2a. The first division electrode 220de1a may include (1-1)-th sensing patterns 221sp1 and a (1-1)-th bridge pattern 221bp1, and the second division electrode 220de2a may include (2-1)-th sensing patterns 222sp1 and a (2-1)-th bridge pattern 222bp1. The first cross electrode 220ce1a may include (1-2)-th sensing patterns 221sp2 and a (1-2)-th bridge pattern 221bp2, and the second cross electrode 220ce2a may include (2-2)-th sensing patterns 222sp2 and a (2-2)-th bridge pattern 222bp2. Each of the first electrode groups 210Gb may include third sensing patterns 210sp and a third bridge pattern 210bp.

In an embodiment, the (1-1)-th sensing patterns 221sp1, the (1-1)-th bridge patterns 221bp1, the (1-2)-th bridge patterns 221bp2, the (2-1)-th sensing patterns 222sp1, the (2-1)-th bridge patterns 222bp1, the (2-2)-th bridge patterns 222bp2, and the third sensing patterns 210sp are disposed on the same layer (or a same height), and for example, may be included in the second conductive layer 204 (see FIG. 4). In an embodiment, the (1-2)-th sensing patterns 221sp2, the (2-2)-th sensing patterns 222sp2, the third bridge patterns 210bp, and the auxiliary electrodes 230s are disposed on the same layer, and for example, may be included in the first conductive layer 202 (see FIG. 6).

The third sensing patterns 210sp may be spaced apart from each other in a second direction DR2. The third sensing patterns 210sp spaced apart from each other in the second direction DR2 may be electrically connected to each other by the third bridge pattern 210bp. In an embodiment of the inventive concept, the third sensing patterns 210sp spaced apart from each other in the second direction DR2 and the third bridge pattern 210bp connecting the third sensing patterns 210sp are disposed on different layers (or heights) and connected through a via hole defined in the intermediate insulating layer 202 (see FIG. 6).

Each of the auxiliary electrodes 230s may extend along the second direction DR2. The third sensing patterns 210sp included in one first electrode group 210Gb may overlap one corresponding auxiliary electrode 230s among the auxiliary electrodes 230s. A hole 230s-h may be defined in each of the auxiliary electrodes 230s. Each of the third bridge patterns 210bp may be surrounded by a corresponding hole 230s-h and insulated from the auxiliary electrode 230s.

The sensor layer 200 according to an embodiment of the inventive concept further includes dummy electrodes DME. The dummy electrodes DME may include first dummy patterns 222sp2_d and second dummy patterns 222bp2_d. In an embodiment, the first dummy patterns 222sp2_d are disposed on the same layer as that on which the (2-2)-th sensing patterns 222sp2 are disposed, and may be included in the second conductive layer 204 (see FIG. 6). In an embodiment, the second dummy patterns 222bp2_d are disposed on the same layer as that on which the (2-2)-th bridge patterns 222bp2 are disposed, and may be included in the first conductive layer 202 (see FIG. 6). Description of the first dummy patterns 222sp2_d and the second dummy patterns 222bp2_d is substantially the same as the description made with reference to FIG. 20C, and thus description overlapping with the above description will not be provided.

FIG. 25 exemplarily illustrates only the first dummy patterns 222sp2_d overlapping the (1-1)-th sensing patterns 221sp1 and the second dummy patterns 222bp2_d disposed therebetween in a plan view, but in an embodiment of the inventive concept, first dummy patterns overlapping the (2-1)-th sensing patterns 222sp1 and second dummy patterns disposed therebetween may be further included.

In an embodiment, patterns illustrated in FIGS. 26A and 26B each have a mesh structure. The mesh structures may each have a plurality of mesh lines. The plurality of mesh lines may each have a straight-lined shape extending in a predetermined direction and may be connected to each other. However, this is merely an example, and at least a portion of each of the plurality of mesh lines may have a curved shape.

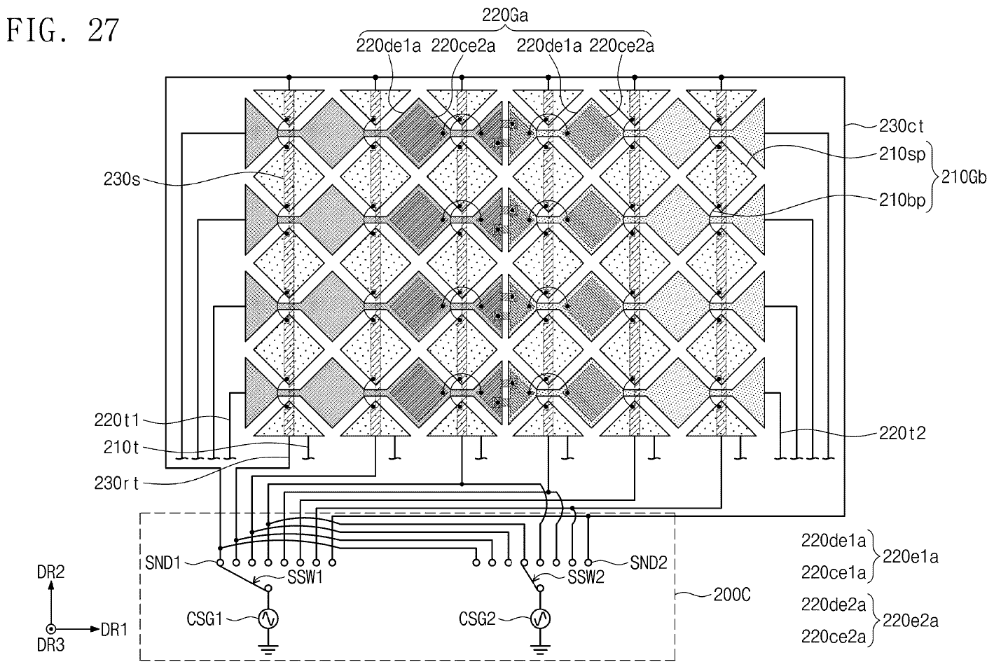

FIG. 27 is a plan view illustrating a portion of a sensor layer and a portion of a sensor driver according to an embodiment of the inventive concept.

Referring to FIGS. 7 and 27, the sensor layer 200 may further include a plurality of loop trace lines 230rt electrically connected to a plurality of auxiliary electrodes 230s. FIG. 27 exemplarily illustrates that the auxiliary electrodes 230s and the loop trace lines 230rt are electrically connected in one-to-one correspondence, but embodiments of the inventive concept are not limited thereto. For example, two or more auxiliary electrodes 230s may be electrically connected to one loop trace line 230rt.

The second mode MD2 (see FIG. 9) may include a charge driving mode and a pen sensing driving mode. FIG. 27 is a diagram illustrating the charge driving mode. A sensor driver 200C may include a first switch SSW1 and a second switch SSW2. A first signal CSG1 may be transmitted to the sensor layer 200 through the first switch SSW1, and a second signal CSG2 may be transmitted to the sensor layer 200 through the second switch SSW2.

Each of the first signal CSG1 and the second signal CSG2 may be a sign wave or square wave signal. In an embodiment, each of the first signal CSG1 and the second signal CSG2 are in a reverse phase relationship. Thus, a direction of current may periodically change in the charge driving mode. In another embodiment of the inventive concept, one of the first signal CSG1 or the second signal CSG2 may be a sign wave or square wave signal, and the other may have a predetermined constant voltage.

In the charge driving mode, the first switch SSW1 and the second switch SSW2 may be electrically connected to at least one among and at least another one among a connection trace line 230ct and the loop trace lines 230rt. FIG. 27 exemplarily illustrates that the first signal CSG1 is provided to the connection trace line 230ct and the second signal CSG2 is provided to one loop trace line 230rt, but embodiments of the inventive concept are not limited thereto. For example, the first signal CSG1 may be provided to two or more lines, and the second signal CSG2 may also be provided to two or more different lines.

In an embodiment of the pen sensing driving mode, all the loop trace lines 230rt are electrically floated, and the connection trace line 230ct is grounded.

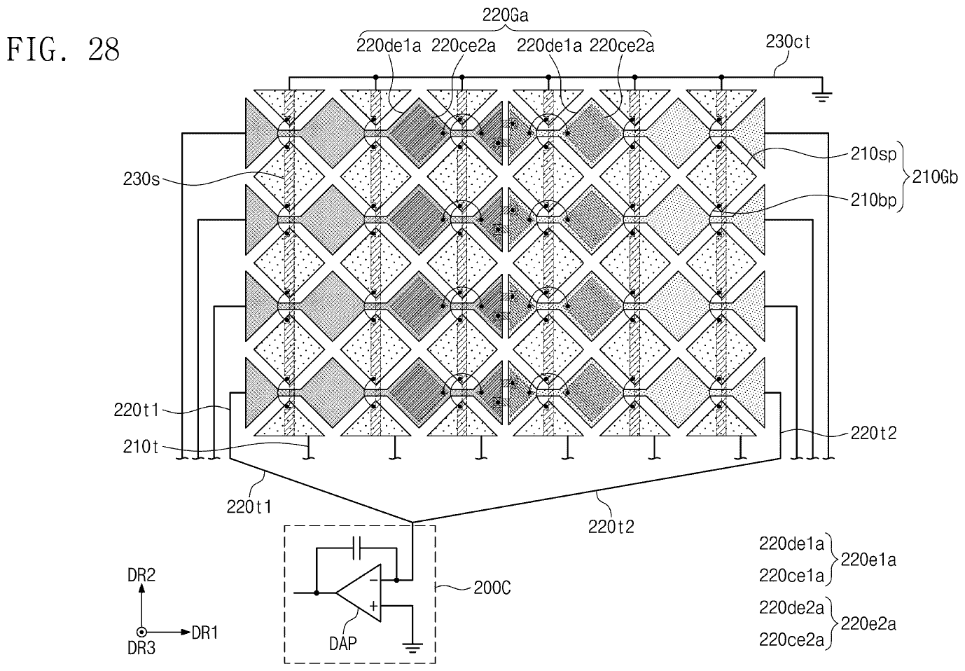

FIG. 28 is a plan view illustrating a portion of a sensor layer and a portion of a sensor driver according to an embodiment of the inventive concept.

Referring to FIGS. 7 and 28, an operation of the sensor layer 200 in the first mode MD1 (see FIG. 9) is exemplarily schematically illustrated.

A sensor driver 200C may include a differential amplifier DAP. In the first mode MD1, an inverting terminal of the differential amplifier DAP may be electrically connected to a first sensing electrode 220e1a and a second sensing electrode 220e2a. That is, in the first mode MD1, the inverting terminal of the differential amplifier DAP may be electrically connected to a first division electrode 220de1a, a first cross electrode 220ce1a, a second division electrode 220de2a, and a second cross electrode 220ce2a. A non-inverting terminal of the differential amplifier DAP may be grounded or applied with a reference voltage.

In an embodiment of the inventive concept, in the first mode MD1, a signal received from the first sensing electrode 220e1a and a signal received from the second sensing electrode 220e2a included in the same group as that in which the first sensing electrode 220e1a is included are all inputted to the inverting terminal of the differential amplifier DAP, and a signal for sensing a touch should not be decreased.

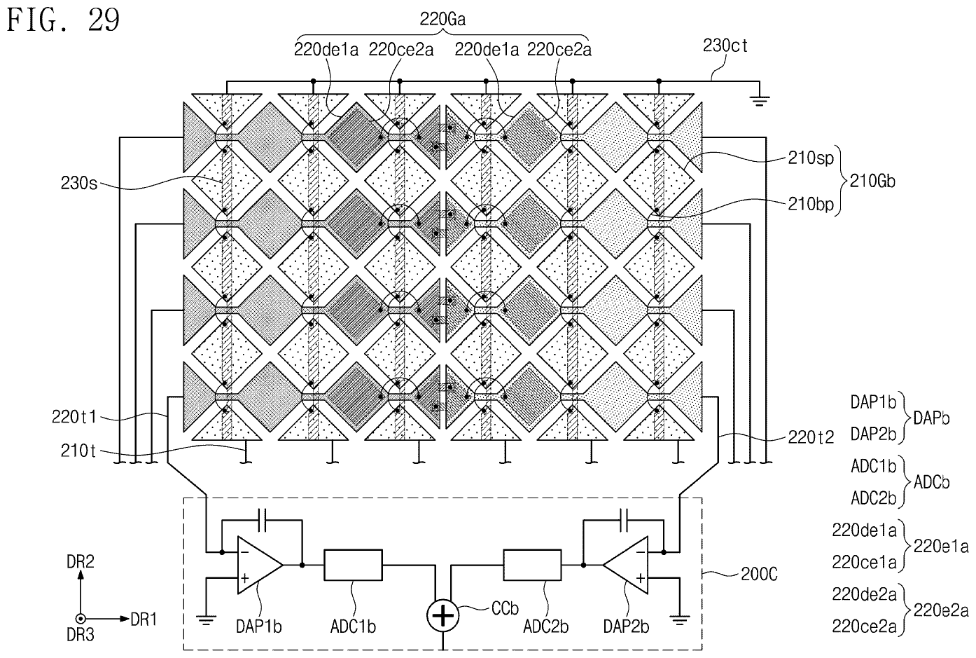

FIG. 29 is a plan view illustrating a portion of a sensor layer and a portion of a sensor driver according to an embodiment of the inventive concept.

Referring to FIGS. 7 and 29, an operation of the sensor layer 200 in the first mode MD1 (see FIG. 9) is exemplarily schematically illustrated.

A sensor driver 200C may include a plurality of differential amplifiers DAPb, a plurality of analog-to-digital converters ADCb, and an adder CCb.

The differential amplifiers DAPb may include a first differential amplifier DAP1b and a second differential amplifier DAP2b. In the first mode MD1 (see FIG. 9), an inverting terminal of the first differential amplifier DAP1b may be electrically connected to first sensing electrodes 220e1a (or, first division electrodes 220de1a and first cross electrodes 220ce1a). A non-inverting terminal of the first differential amplifier DAP1b may be grounded or applied with a reference voltage. In the first mode MD1 (see FIG. 9), an inverting terminal of the second differential amplifier DAP2b may be electrically connected to second sensing electrodes 220e2a (or, second division electrodes 220de2a and second cross electrodes 220ce2a). A non-inverting terminal of the second differential amplifier DAP2b may be grounded or applied with a reference voltage.

The analog-to-digital converters ADCb may include a first analog-to-digital converter ADC1b and a second analog-to-digital converter ADC2b. The first analog-to-digital converter ADC1b may receive a first analog signal from the first differential amplifier DAP1b and convert the received signal into a first digital signal. The second analog-to-digital converter ADC2b may receive a second analog signal from the second differential amplifier DAP2b and convert the received signal into a second digital signal. The adder CCb may sum the first and second digital signals provided from the analog-to-digital converters ADCb to output output data.

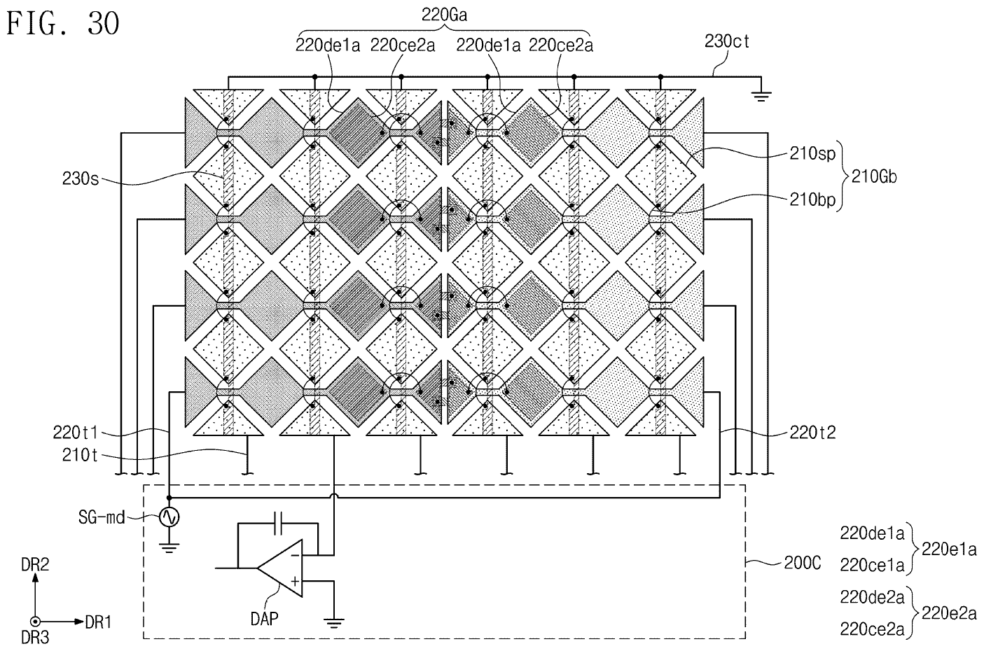

FIG. 30 is a plan view illustrating a portion of a sensor layer and a portion of a sensor driver according to an embodiment of the inventive concept.

Referring to FIGS. 7 and 30, an operation of the sensor layer 200 in the first mode MD1 (see FIG. 9) is exemplarily illustrated. The first mode MD1 may be a mutual capacitance detecting mode.

In the first mode MD1, a sensor driver 200C may sequentially provide a transmission signal SG-md to second electrode groups 220Ga. For example, the transmission signal SG-md may be provided to each of a first sensing electrode 220e1a and a second sensing electrode 220e2a included in one second electrode group 220Ga.

The sensor driver 200C may detect a coordinate based on the first input 2000 (see FIG. 4) by using a reception signal detected through first electrode groups 210Gb. For example, the sensor driver 200C may be configured to sense a change in mutual capacitance between the first electrode groups 210Gb and the second electrode groups 220Ga to calculate an input coordinate.

According to the description above, an input by a pen or a touch input may be sensed by using a sensor layer. Thus, since it may not be necessary to add an additional component (e.g., a digitizer) to an electronic device for sensing a pen, an increase in thickness, an increase in weight, and deterioration in flexibility of the electronic device according to addition of a digitizer should not occur. In addition, at least one electrode group included in the sensor layer may include two division electrodes of which routing directions are different. In this case, directions of current of signals received from the two division electrodes may be opposed to each other, and noise generated in the two division electrodes may be substantially the same. In a pen sensing driving mode, a sensor driver may generate an output signal by differentiating two signals using a differential amplifier. In this case, noise may be removed, and a magnitude of the output signal may be increased. Thus, a signal-to-noise ratio may increase, thereby providing the electronic device having an increased sensing sensitivity. In addition, since at least one electrode group in the sensor layer may include two division electrodes, both a touch input and a pen input may be sensed. Thus, a degree of freedom in design of electrodes in the sensor layer may be increased, and securing of a bandwidth may be facilitated.

Although various embodiments of the inventive concept have been described, it is understood that the inventive concept should not be limited to these embodiments, but various changes and modifications may be made by one ordinary skilled in the art within the spirit and scope of the inventive concept.

What is claimed is:

1. An electronic device comprising:
a sensor layer; and
a sensor driver configured to drive the sensor layer and operate in one of a first mode for sensing a touch input and a second mode for sensing a pen input,
wherein the sensor layer comprises:
a plurality of first electrode groups arranged along a first direction; and
a plurality of second electrode groups arranged along a second direction crossing the first direction, crossing the plurality of first electrode groups, and each including a first sensing electrode and a second sensing electrode,
wherein the first sensing electrode comprises:
a first division electrode; and
a first cross electrode electrically connected to the first division electrode, wherein the second sensing electrode comprises:
a second division electrode spaced apart from the first division electrode in the first direction; and
a second cross electrode electrically connected to the second division electrode, and
at least a portion of the first cross electrode overlaps the second division electrode, and at least a portion of the second cross electrode overlaps the first division electrode.

2. The electronic device of claim 1, wherein in the second mode, the sensor driver is configured to receive a first signal from the first sensing electrode, and receive a second signal from the second sensing electrode.

3. The electronic device of claim 1, wherein the sensor layer further comprises a first crossing trace line electrically connected to the first sensing electrode and a second crossing trace line electrically connected to the second sensing electrode,
the first crossing trace line is connected to the first division electrode, and
the second crossing trace line is connected to the second division electrode.

4. The electronic device of claim 3, wherein the first crossing trace line is connected to one end of the first division electrode, and
the second crossing trace line is connected to one end of the second division electrode.

5. The electronic device of claim 1, wherein a length of the first cross electrode in the first direction is smaller than a length of the second division electrode in the first direction, and
a length of the second cross electrode in the first direction is smaller than a length of the first division electrode in the first direction.

6. The electronic device of claim 1, wherein a maximum width of the first cross electrode in the second direction is smaller than a maximum width of the second division electrode in the second direction, and
a maximum width of the second cross electrode in the second direction is smaller than a maximum width of the first division electrode in the second direction.

7. The electronic device of claim 1, wherein the sensor driver comprises a differential amplifier, and in the second mode, an inverting terminal of the differential amplifier is electrically connected to the first sensing electrode, and a non-inverting terminal of the differential amplifier is electrically connected to the second sensing electrode.

8. The electronic device of claim 1, wherein the sensor driver comprises a first differential amplifier, a second differential amplifier, and a third differential amplifier,
in the second mode, each of the first differential amplifier and the second differential amplifier receives signals from the plurality of second electrode groups, an inverting terminal of the third differential amplifier receives a signal outputted from the first differential amplifier, and a non-inverting terminal of the third differential amplifier receives a signal outputted from the second differential amplifier.

9. The electronic device of claim 8, wherein the plurality of second electrode groups comprise a (2-1)-th electrode group and a (2-2)-th electrode group spaced apart from the (2-1)-th electrode group in the second direction,
in the second mode, an inverting terminal of the first differential amplifier is electrically connected to the first sensing electrode of the (2-1)-th electrode group, and a non-inverting terminal of the first differential amplifier is electrically connected to the second sensing electrode of the (2-1)-th electrode group, and
in the second mode, an inverting terminal of the second differential amplifier is electrically connected to the first sensing electrode of the (2-2)-th electrode group, and a non-inverting terminal of the second differential amplifier is electrically connected to the second sensing electrode of the (2-2)-th electrode group.

10. The electronic device of claim 8, wherein the plurality of second electrode groups comprise a (2-1)-th electrode group and a (2-2)-th electrode group spaced apart from the (2-1)-th electrode group in the second direction,
in the second mode, an inverting terminal of the first differential amplifier is electrically connected to the first sensing electrode of the (2-2)-th electrode group, and a non-inverting terminal of the first differential amplifier is electrically connected to the first sensing electrode of the (2-1)-th electrode group, and
in the second mode, an inverting terminal of the second differential amplifier is electrically connected to the second sensing electrode of the (2-1)-th electrode group, and a non-inverting terminal of the second differential amplifier is electrically connected to the second sensing electrode of the (2-2)-th electrode group.

11. The electronic device of claim 1, wherein the sensor driver comprises a plurality of differential amplifiers and an analog-to-digital converter,
in the second mode, the plurality of differential amplifiers are connected, in one-to-one correspondence, to the plurality of first sensing electrodes and the plurality of second sensing electrodes of the plurality of second electrode groups,
the analog-to-digital converter receives a plurality of signals from the plurality of differential amplifiers, and
the sensor driver performs a difference operation on data outputted from the analog-to-digital converter.

12. The electronic device of claim 1, wherein each of the plurality of first electrode groups comprises a third sensing electrode and a fourth sensing electrode,
the third sensing electrode comprises:
a third division electrode; and
a third cross electrode electrically connected to the third division electrode, the fourth sensing electrode comprises:
a fourth division electrode spaced apart from the third division electrode in the first direction; and
a fourth cross electrode electrically connected to the fourth division electrode, and
at least a portion of the third cross electrode overlaps the fourth division electrode, and at least a portion of the fourth cross electrode overlaps the third division electrode.

13. The electronic device of claim 12, wherein in the second mode, the sensor driver is configured to receive a first signal from the first sensing electrode, receive a second signal from the second sensing electrode, receive a third signal from the third sensing electrode, and receive a fourth signal from the fourth sensing electrode.

14. The electronic device of claim 12, wherein the first division electrode comprises a plurality of (1-1)-th sensing patterns and a (1-1)-th bridge pattern, and the first cross electrode comprises a plurality of (1-2)-th sensing patterns and a (1-2)-th bridge pattern,
the second division electrode comprises a plurality of (2-1)-th sensing patterns and a (2-1)-th bridge pattern, and the second cross electrode comprises a plurality of (2-2)-th sensing patterns and a (2-2)-th bridge pattern,
the third division electrode comprises a plurality of (3-1)-th sensing patterns and a (3-1)-th bridge pattern, and the third cross electrode comprises a plurality of (3-2)-th sensing patterns and a (3-2)-th bridge pattern, and
the fourth division electrode comprises a plurality of (4-1)-th sensing patterns and a (4-1)-th bridge pattern, and the fourth cross electrode comprises a plurality of (4-2)-th sensing patterns and a (4-2)-th bridge pattern.

15. The electronic device of claim 14, wherein the plurality of (1-1)-th sensing patterns, the (1-1)-th bridge pattern, the (1-2)-th bridge pattern, the plurality of (2-1)-th sensing patterns, the (2-1)-th bridge pattern, the (2-2)-th bridge pattern, the plurality of (3-1)-th sensing patterns, and the plurality of (4-1)-th sensing patterns are disposed on a same first layer, and
the plurality of (1-2)-th sensing patterns, the plurality of (2-2)-th sensing patterns, the plurality of (3-2)-th sensing patterns, the (3-1)-th bridge pattern, the (3-2)-th bridge pattern, the plurality of (4-2)-th sensing patterns, the (4-1)-th bridge pattern, and the (4-2)-th bridge pattern are disposed on a same second layer.

16. The electronic device of claim 14, wherein the plurality of (1-2)-th sensing patterns overlap some (2-1)-th sensing patterns among the plurality of (2-1)-th sensing patterns, and the plurality of (2-2)-th sensing patterns overlap some (1-1)-th sensing patterns among the plurality of (1-1)-th sensing patterns, and
the plurality of (3-2)-th sensing patterns overlap some (4-1)-th sensing patterns among the plurality of (4-1)-th sensing patterns, and the plurality of (4-2)-th sensing patterns overlap some (3-1)-th sensing patterns among the plurality of (3-1)-th sensing patterns.

17. The electronic device of claim 14, wherein the sensor layer further comprises a dummy electrode including a plurality of first dummy patterns and a plurality of second dummy patterns,
the first dummy patterns include patterns having a same shape as a shape of at least a portion among the (1-2)-th sensing patterns, the (2-2)-th sensing patterns, the (3-2)-th sensing patterns, and the (4-2)-th sensing patterns, and
the second dummy patterns include patterns having a same shape as a shape of at least a portion among the (1-2)-th bridge pattern, the (2-2)-th bridge pattern, the (3-2)-th bridge pattern, and the (4-2)-th bridge pattern.

18. The electronic device of claim 1, wherein the sensor layer further comprises a plurality of auxiliary electrodes respectively overlapping the plurality of first electrode groups, and a connection trace line connecting the plurality of auxiliary electrodes to each other.

19. The electronic device of claim 18, wherein the sensor layer further comprises a plurality of first trace lines electrically connected, in one-to-one correspondence, to the plurality of first electrode groups, and the plurality of first trace lines are spaced apart from the connection trace line with the plurality of first electrode groups therebetween.

20. The electronic device of claim 18, wherein the first division electrode comprises a plurality of (1-1)-th sensing patterns and a (1-1)-th bridge pattern, and the first cross electrode comprises a plurality of (1-2)-th sensing patterns and a (1-2)-th bridge pattern,
the second division electrode comprises a plurality of (2-1)-th sensing patterns and a (2-1)-th bridge pattern, and the second cross electrode comprises a plurality of (2-2)-th sensing patterns and a (2-2)-th bridge pattern,
each of the plurality of first electrode groups comprises a plurality of third sensing patterns and a third bridge pattern,
the plurality of (1-1)-th sensing patterns, the (1-1)-th bridge pattern, the (1-2)-th bridge pattern, the plurality of (2-1)-th sensing patterns, the (2-1)-th bridge pattern, the (2-2)-th bridge pattern, and the plurality of third sensing patterns are disposed on a same first layer, and
the plurality of (1-2)-th sensing patterns, the plurality of (2-2)-th sensing patterns, the third bridge pattern, and the plurality of auxiliary electrodes are disposed on a same second layer.

21. The electronic device of claim 20, wherein the plurality of third sensing patterns overlap one corresponding auxiliary electrode among the plurality of auxiliary electrodes, and
at least one hole surrounding the third bridge pattern is in the one auxiliary electrode.

22. The electronic device of claim 18, wherein the sensor layer further comprises a plurality of loop trace lines electrically connected to the plurality of auxiliary electrodes,
the second mode comprises a charge driving mode and a pen sensing driving mode,
the sensor driver is configured to apply a first signal to at least one among the connection trace line and the plurality of loop trace lines and apply a second signal to another at least one among the connection trace line and the plurality of loop trace lines in the charge driving mode, and
in the pen sensing driving mode, all the plurality of loop trace lines are floated.

23. The electronic device of claim 18, wherein the sensor driver comprises a differential amplifier, and
in the first mode, an inverting terminal of the differential amplifier is electrically connected to the first sensing electrode and the second sensing electrode.

24. The electronic device of claim 18, wherein the sensor driver comprises a first differential amplifier, a second differential amplifier, a first analog-to-digital converter, and a second analog-to-digital converter,
in the first mode, an inverting terminal of the first differential amplifier is electrically connected to the first sensing electrode, and an inverting terminal of the second differential amplifier is electrically connected to the second sensing electrode,
the first analog-to-digital converter receives a signal from the first differential amplifier, and the second analog-to-digital converter receives a signal from the second differential amplifier, and
the sensor driver sums data outputted from the first analog-to-digital converter and from the second analog-to-digital converter.

25. The electronic device of claim 18, wherein in the first mode, the sensor driver provides a same signal to the first sensing electrode and the second sensing electrode, and receives signals provided from the plurality of first electrode groups.

26. An electronic device comprising:
a sensor layer; and
a sensor driver configured to drive the sensor layer and operate in one of a first mode for sensing a touch input and a second mode for sensing a pen input,
wherein the sensor layer comprises:
a plurality of first electrode groups arranged along a first direction; and
a plurality of second electrode groups arranged along a second direction crossing the first direction and crossing the plurality of first electrode groups, and
each of the plurality of second electrode groups includes a first sensing electrode and a second sensing electrode, and a plurality of coupling capacitors are between the first sensing electrode and the second sensing electrode.

27. The electronic device of claim 26,
wherein the first sensing electrode comprises:
a first division electrode; and
a first cross electrode electrically connected to the first division electrode, wherein the second sensing electrode comprises:
a second division electrode spaced apart from the first division electrode in the first direction; and
a second cross electrode electrically connected to the second division electrode, and
the plurality of coupling capacitors comprise a first coupling capacitors between the first division electrode and the second cross electrode and a second coupling capacitors between the second division electrode and the first cross electrode.

28. The electronic device of claim 26, wherein in the second mode, the sensor driver is configured to receive a first signal from the first sensing electrode, and receive a second signal from the second sensing electrode.

29. An electronic device comprising:
a sensor layer; and
a sensor driver configured to drive the sensor layer and operate in one of a first mode for sensing a touch input and a second mode for sensing a pen input,
wherein the sensor layer comprises:
a plurality of first electrode groups arranged along a first direction; and
a plurality of second electrode groups arranged along a second direction crossing the first direction and crossing the plurality of first electrode groups,
each of the plurality of second electrode groups includes a first division electrode and a second division electrode spaced apart from each other in the first direction, and
in the second mode, the sensor driver is configured to receive a first signal from the first division electrode, and receive a second signal from the second division electrode.

30. The electronic device of claim 29, wherein each of the plurality of second electrode groups further comprises:
a first cross electrode electrically connected to the first division electrode; and
a second cross electrode electrically connected to the second division electrode, and
at least a portion of the first cross electrode overlaps the second division electrode, and at least a portion of the second cross electrode overlaps the first division electrode.
